(19) United States
(12) Patent Application Publication
(10) Pub. No.: US 2010/0039628 A1
(43) Pub. Date: Feb. 18, 2010

(54) Cleaning tool, cleaning method, and device fabricating method

(75) Inventors: Kenichi Shiraishi, Saitama-shi (JP); Akikazu Tanimoto, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/382,544

(22) Filed: Mar. 18, 2009

Related U.S. Application Data
(60) Provisional application No. 61/064,956, filed on Apr. 4, 2008.
(60) Provisional application No. 61/136,559, filed on Sep. 15, 2008.

(30) Foreign Application Priority Data
Mar. 19, 2008 (JP) 2008-072524
Aug. 26, 2008 (JP) 2008-216525

(51) Int. Cl. G03B 27/52

(52) U.S. Cl. 355/30

(57) ABSTRACT

A cleaning tool is loaded onto an exposure apparatus, which exposes a substrate with exposure light, and cleans a member inside the exposure apparatus. The cleaning tool comprises: a base member; and a cleaning member that is disposed on the base member and permeated with a cleaning liquid.

### CROSS-REFERENCE TO RELATED APPLICATION

This application is a non-provisional application claiming priority to and the benefit of U.S. provisional application No. 61/064,956, filed Apr. 4, 2008 and U.S. provisional application No. 61/136,559, filed Sep. 15, 2008, and claims priority to Japanese Patent Application Nos. 2008-072524, filed Mar. 19, 2008 and 2008-216525, filed Aug. 26, 2008. The entire contents of which are incorporated herein by reference.

### BACKGROUND

1. Field of the Invention

The present invention relates to: a cleaning tool that cleans a member inside an exposure apparatus; a cleaning method; and a device fabricating method.

2. Description of Related Art

In microdevice fabricating processes, an exposure apparatus that exposes a substrate with exposure light is used. If either a member inside the exposure apparatus or a component, or both, is contaminated, then exposure failures, such as defects in the pattern formed in the substrate, might occur, and defective devices might be produced as a result. Consequently, a technology for cleaning either a member inside an exposure apparatus or a component, or both, has been proposed, as disclosed in, for example, U.S. Pat. No. 6,496,257 and U.S. Patent Application Publication No. 2006/0023185.

A demand exists for technology that can clean either a member inside an exposure apparatus or a component, or both, efficiently and satisfactorily.

An object of the present invention is to provide a cleaning tool and a cleaning method that can prevent exposure failures from occurring. Another object of the present invention is to provide a device fabricating method that can prevent defective devices from being produced.

### SUMMARY

A first aspect of the invention of the present invention provides a cleaning tool that is loaded onto an exposure apparatus, which exposes a substrate with exposure light, and cleans a member inside the exposure apparatus, comprising: a base member; and a cleaning member that is disposed on the base member and permeated with a cleaning liquid.

A second aspect of the invention of the present invention provides a cleaning method, comprising the steps of: loading a cleaning tool according to the first aspect of the invention onto an exposure apparatus, which exposes a substrate with an exposure light; and cleaning at least part of a member inside the exposure apparatus by bringing the cleaning member of the cleaning tool and the member inside the exposure apparatus into contact with one another.

A third aspect of the invention of the present invention provides a device fabricating method, comprising the steps of: loading a cleaning tool according to the first aspect of the invention onto an exposure apparatus that exposes a substrate with an exposure light; cleaning at least part of a member inside the exposure apparatus by bringing the cleaning member of the cleaning tool and the member inside the exposure apparatus into contact with one another; after the cleaning, exposing the substrate using the exposure apparatus; and developing the exposed substrate.

A fourth aspect of the invention provides a cleaning tool that is loaded into an exposure apparatus, which exposes a substrate with exposure light through a first liquid, and cleans a prescribed member inside the exposure apparatus, comprising: a porous plate that has a first surface, a second surface on the opposite side of the first surface, and a plurality of holes wherethrough the first surface and the second surface communicate; a base member that supports the porous plate; and an internal space that faces the second surface; wherein, a second liquid for cleaning is held in the internal space.

A fifth aspect of the invention provides a cleaning method, comprising the steps of: loading a cleaning tool according to the fourth aspect of the invention into an exposure apparatus, which exposes a substrate with exposure light through a first liquid; and cleaning the front surface of a prescribed member inside the exposure apparatus with a liquid mixture of the first liquid and the second liquid created on the first surface by bringing the first liquid and the first surface into contact with one another.

A sixth aspect of the invention provides a device fabricating method, comprising the steps of: loading a cleaning tool according to the fourth aspect of the invention into an exposure apparatus, which exposes a substrate with exposure light through a first liquid; and cleaning at least part of a prescribed member inside the exposure apparatus with a liquid mixture of the first liquid and the second liquid created on the first surface by bringing the first liquid and the first surface into contact with one another; after the cleaning, exposing the substrate using the exposure apparatus; and developing the exposed substrate.

A seventh aspect of the invention provides a cleaning tool that is loaded onto an exposure apparatus, which exposes a substrate with an exposure light, and cleans a member inside the exposure apparatus, comprising: a base member; and a liquid holding member that is provided on the base member and is capable of holding a cleaning liquid.

A eighth aspect of the invention provides a cleaning method, comprising the steps of: loading a cleaning tool according to the seventh aspect of the invention into an exposure apparatus, which exposes a substrate with exposure light; and cleaning a front surface of a prescribed member inside the exposure apparatus with a cleaning liquid held by a liquid holding member of the cleaning tool.

A ninth aspect of the invention provides a device fabricating method, comprising the steps of: loading a cleaning tool according to seventh aspect of the invention into an exposure apparatus, which exposes a substrate with exposure light; and cleaning a front surface of a prescribed member inside the exposure apparatus with a cleaning liquid held by a liquid holding member of the cleaning tool; after the cleaning, exposing a substrate using the exposure apparatus; and developing the exposed substrate.

The present invention can prevent exposure failures from occurring. In addition, the present invention can prevent defective devices from being produced.

### BRIEF DESCRIPTION OF THE DRAWINGS

FIG. 1 is an oblique view that shows one example of a cleaning tool according to a first embodiment.

FIG. 2 is a side cross sectional view that shows one example of the cleaning tool according to the first embodiment.

FIG. 3 is a schematic block diagram that shows one example of an exposure apparatus according to the first embodiment.

FIG. 4 is a side cross sectional view that shows the vicinity of a liquid immersion member according to the first embodiment.

FIG. 5 is a side cross sectional view that shows the vicinity of the liquid immersion member according to the first embodiment.

FIG. 6 is an oblique view from the lower side that shows the liquid immersion member according to the first embodiment.

FIG. 7A shows the state wherein the cleaning tool according to the first embodiment is held by a substrate holding part.

FIG. 7B shows the state wherein the cleaning tool according to the first embodiment is held by a substrate holding part.

FIG. 8 is a flowchart that shows one example of a cleaning method according to the first embodiment.

FIG. 9A shows one example of a cleaning method according to the first embodiment.

FIG. 9B shows one example of a cleaning method according to the first embodiment.

FIG. 10 is a schematic drawing that shows one example of the cleaning method according to the first embodiment.

FIG. 11 is a schematic drawing that shows one example of the cleaning method according to the first embodiment.

FIG. 12 is an oblique view from the lower side that shows the liquid immersion member according to a second embodiment.

FIG. 13 shows the state wherein the cleaning tool according to the second embodiment is held by the substrate holding part.

FIG. 14 is a side cross sectional view that shows one example of the cleaning tool.

FIG. 15 is a side cross sectional view that shows one example of the cleaning tool.

FIG. 16 shows one example of the cleaning tool and the cleaning method.

FIG. 17 shows one example of the cleaning tool and the cleaning method.

FIG. 18 is a side cross sectional view that shows one example of a cleaning tool according to a first embodiment.

FIG. 19 is a plan view that shows one example of the cleaning tool according to the first embodiment.

FIG. 20 is a schematic block diagram that shows one example of an exposure apparatus according to the first embodiment.

FIG. 21 is a side cross sectional view that shows the vicinity of a liquid immersion member according to the first embodiment.

FIG. 22A shows the state wherein the cleaning tool according to the first embodiment is held by a substrate holding part.

FIG. 22B shows the state wherein the cleaning tool according to the first embodiment is held by a substrate holding part.

FIG. 23 shows the state wherein the cleaning tool according to the first embodiment is supported by a transport member.

FIG. 24 is a flowchart that shows one example of a cleaning method according to the first embodiment.

FIG. 25A is schematic drawing for explaining the cleaning method according to the first embodiment.

FIG. 25B is schematic drawing for explaining the cleaning method according to the first embodiment.

FIG. 26 is a schematic drawing for explaining the cleaning method according to the first embodiment.

FIG. 27 is a schematic drawing for explaining the cleaning method according to the first embodiment.

FIG. 28 is a side cross sectional view that shows one example of the cleaning tool according to a second embodiment.

FIG. 29 is a partial plan view of the cleaning tool according to the second embodiment.

FIG. 30A is partial plan view of the cleaning tool according to the second embodiment.

FIG. 30B is partial plan view of the cleaning tool according to the second embodiment.

FIG. 31 is a flow chart for explaining one example of a process of fabricating a microdevice.

### DESCRIPTION OF EMBODIMENTS

The following text explains the embodiments of the present invention referencing the drawings, but the present invention is not limited thereto. The explanation below defines an XYZ orthogonal coordinate system, and the positional relationships among members are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions. In addition, the rotational (inclined) directions around the X, Y, and Z axes are the θX, θY, and θZ directions, respectively.

### First Embodiment

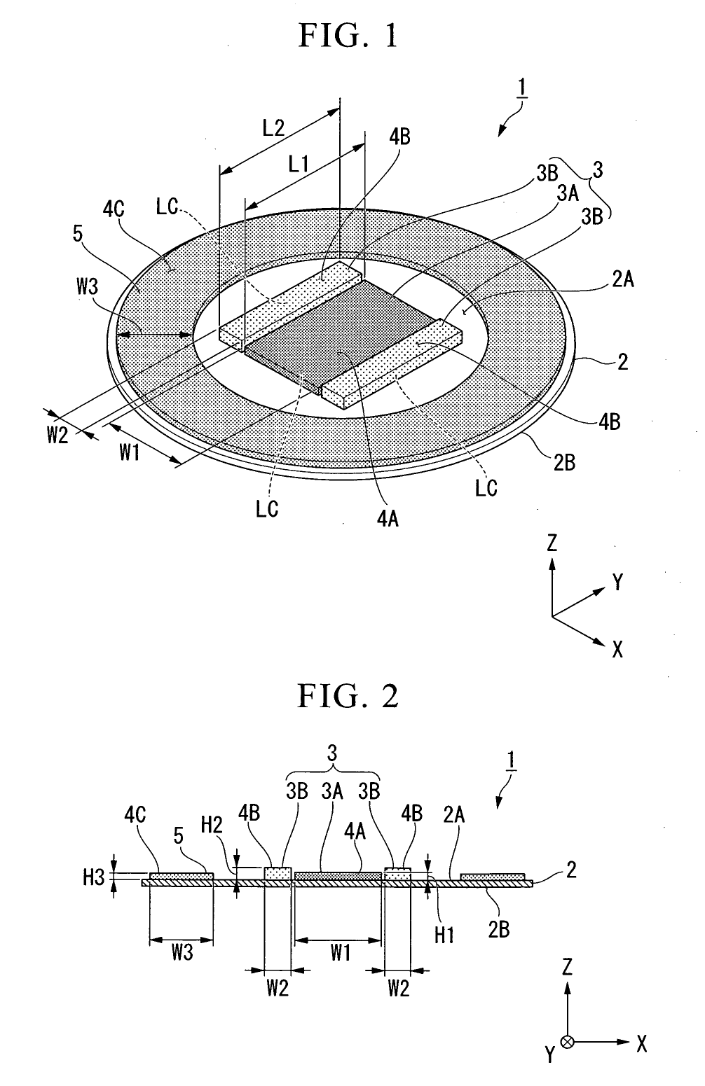

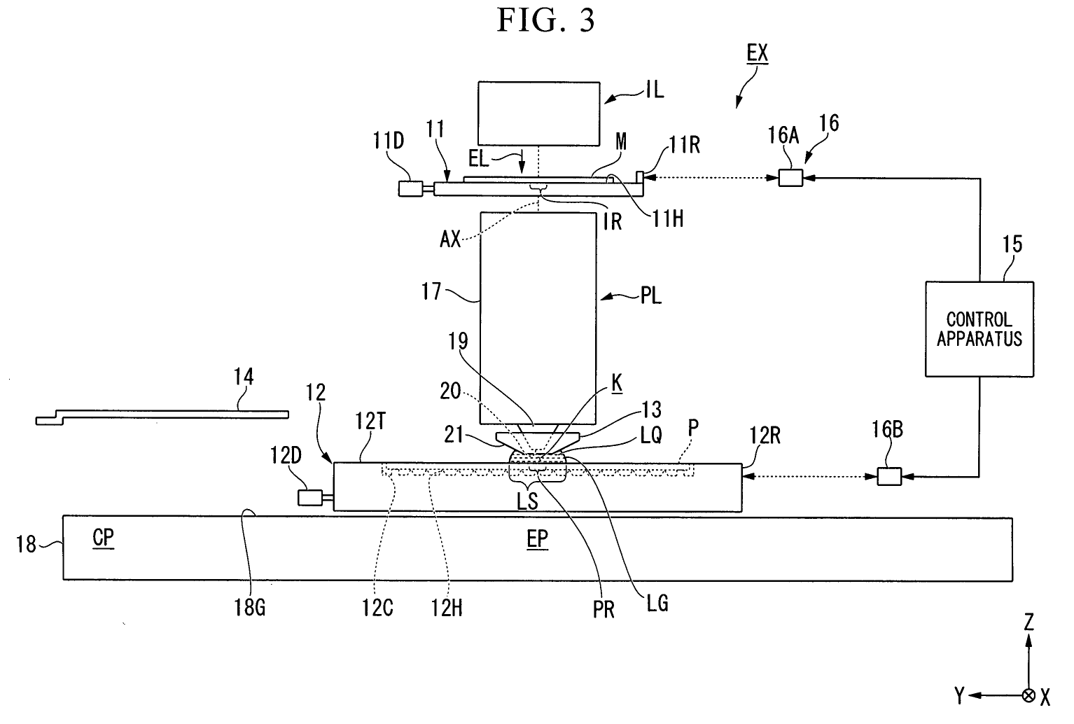

A first embodiment will now be explained. FIG. 1 is an oblique view that shows one example of a cleaning tool 1 according to a first embodiment, and FIG. 2 is a side cross sectional view thereof. As discussed below, the cleaning tool 1 is transported to an exposure apparatus EX, which exposes a substrate P with exposure light EL, and cleans at least part of a member inside the exposure apparatus EX.

In FIG. 1 and FIG. 2, the cleaning tool 1 comprises: a base member 2; and a cleaning member 3, which is disposed on the base member 2 and permeated with a cleaning liquid LC.

The base member 2 is a plate member and has a front surface 2A and a rear surface 2B. In the present embodiment, the base member 2 has a substantially circular external shape within the XY plane. In the present embodiment, the external shape of the base member 2 is substantially the same as that of the substrate P. The base member 2 is made of, for example, stainless steel.

The cleaning member 3 contacts a front surface of the member, which is to be cleaned, disposed inside the exposure apparatus EX and then cleans that front surface. The cleaning member 3 is permeated with the cleaning liquid LC. In the present embodiment, the cleaning member 3 is a sponge. Accordingly, the cleaning member 3 can be permeated with the cleaning liquid LC. A cleaning liquid supply source (not shown) supplies the cleaning liquid LC to the cleaning member 3, and the cleaning liquid LC is held by the cleaning member 3. The supply of the cleaning liquid LC to the cleaning member 3 from the cleaning liquid supply source (not shown) may be performed either automatically or by an operator and either inside or outside of the exposure apparatus EX.

A sponge made of, for example, polyvinyl alcohol (i.e., a PVA sponge) or a sponge made of urethane (i.e., a urethane sponge) can be used as the sponge of the cleaning member 3. Furthermore, the sponge's material is not limited to those materials mentioned above and may be any material provided it does not produce contaminants such as foreign matter.

The cleaning liquid LC is a liquid that is capable of cleaning the member inside the exposure apparatus EX. The cleaning liquid LC is also capable of eliminating foreign matter (i.e., contaminants) that adheres to the member inside the exposure apparatus EX. An alkali cleaning liquid that contains, for example, alkali can be used as the cleaning liquid LC. The alkali may be, for example, ammonia. Using the alkali cleaning liquid as the cleaning liquid LC makes it possible to satisfactorily eliminate contaminants, such as organic substances, that adhere to the member inside the exposure apparatus EX. For example, an aqueous solution of tetramethyl ammonium hydroxide (TMAH) can be used as the cleaning liquid LC. In addition, water (i.e., pure water) can also be used as the cleaning liquid LC. Furthermore, isopropyl alcohol (IPA) can be used as the liquid.

In the present embodiment, the cleaning member 3 comprises a first portion 3A and second portions 3B. In the present embodiment, the first portion 3A and the second portions 3B are spaced apart on the base member 2. Where appropriate in the explanation below, the first portion 3A of the cleaning member 3 is called the first cleaning member 3A, and the second portions 3B are called the second cleaning members 3B.

In the present embodiment, the first cleaning member 3A and the second cleaning members 3B are formed from the same material. In the present embodiment, both the first and second cleaning members 3A, 3B are PVA sponges. Furthermore, both the first and second cleaning members 3A, 3B may be urethane sponges.

Furthermore, the first cleaning member 3A and the second cleaning members 3B may be formed from different materials. For example, the sponge material of either the first cleaning member 3A or the second cleaning members 3B may be PVA and the other may be urethane.

In addition, the porosities of the first cleaning member 3A and the second cleaning members 3B may be different. Porosity is defined as the volumetric percentage of the geometric (i.e., external) volume of the porous member (e.g., a sponge) occupied by pores. In other words, porosity is the percentage content of pores per unit of volume.

In the present embodiment, both the first cleaning member 3A and the second cleaning members 3B are permeated with the cleaning liquid LC. Namely, in the present embodiment, the cleaning liquid LC includes cleaning liquid that permeates the first cleaning member 3A and cleaning liquid that permeates the second cleaning members 3B.

In the present embodiment, the cleaning liquid that permeates the first cleaning member 3A and the cleaning liquid that permeates the second cleaning members 3B are the same type of liquid.

Furthermore, the cleaning liquid that permeates the first cleaning member 3A and the cleaning liquid that permeates the second cleaning members 3B may be different types of liquid. In addition, either the first cleaning member 3A or the second cleaning members 3B may be permeated with one of the cleaning liquids and the other may be permeated with the other cleaning liquid.

The second cleaning members 2B are disposed at least partly around the first cleaning member 3A. In the present embodiment, the first cleaning member 3A is disposed at substantially the center of the front surface 2A of the base member 2. In the present embodiment, the first cleaning member 3A has a rectangular shape within an XY plane parallel to the front surface 2A. The second cleaning members 2B are disposed at two locations around the first cleaning member 3A. Namely, in the present embodiment, there are two second cleaning members 2B. The two second cleaning members 2B have substantially the same size and shape.

In the present embodiment, the second cleaning members 2B are disposed on opposite sides of the first cleaning member 3A within the XY plane. Namely, within the XY plane, one of the second cleaning members 2B is disposed on one side (i.e., the +X side) of the first cleaning member 3A, and the other second cleaning member 2B is disposed on the other side (i.e., the −X side) of the first cleaning member 3A. In the present embodiment, a size L1 of an upper surface 4A of the first cleaning member 3A in the Y axial directions is substantially the same as a size L2 of upper surfaces 4B of the second cleaning members 2B. In the X axial directions, on the other hand, a size W1 of the upper surface 4A of the first cleaning member 3A is different from a size W2 of the upper surfaces 4B of the second cleaning members 2B. In the present embodiment, the size W1 is larger than the size W2.

In the present embodiment, the first cleaning member 3A has a first height H1 with respect to the front surface 2A of the base member 2, and the second cleaning members 2B each have a second height H2 with respect to the front surface 2A of the base member 2. The first height H1 is the distance between the front surface 2A of the base member 2 and the upper surface 4A of the first cleaning member 3A in the Z axial directions (i.e., in the normal line directions of the front surface 2A of the base member 2). The second height H2 is the distance between the front surface 2A of the base member 2 and the upper surface 4B of each of the second cleaning members 2B in the Z axial directions. The first and second heights H1, H2 are heights in the state wherein the first and second cleaning members 3A, 3B are not compressed (i.e., the state wherein external forces are not applied). In addition, in the present embodiment, the upper surfaces 4A, 4B are substantially flat in the state wherein the first and second cleaning members 3A, 3B are not compressed (i.e., the state wherein external forces are not applied). In addition, the front surface 2A of the base member 2, the upper surface 4A of the first cleaning member 3A, and the upper surfaces 4B of the second cleaning members 3B are all substantially parallel. Furthermore, at least one surface selected from the group consisting of the front surface 2A of the base member 2, the upper surface 4A of the first cleaning member 3A, and the upper surfaces 4B of the second cleaning members 3B may be nonparallel to the other surfaces. In addition, the upper surface 4A of the first cleaning member 3A and the upper surface 4B of the second cleaning members 3B may be nonparallel.

The first height H1 and the second height H2 are prescribed in accordance with a profile (shape) of the front surface of the member, which is to be cleaned, disposed inside the exposure apparatus EX. In the present embodiment, the second height H2 is greater than the first height H1. Namely, the second cleaning members 3B are taller than the cleaning member 3A with respect to the front surface 2A of the base member 2.

In addition, in the present embodiment, the cleaning tool 1 is disposed above the base member 2 and comprises a circumferential wall member 5, which is disposed around the cleaning member 3. The circumferential wall member 5 is disposed at the outer edge of the front surface 2A of the base member 2. The circumferential wall member 5 is an annular member that has a prescribed width W3.

The circumferential wall member 5 prevents the cleaning liquid LC from leaking out. Namely, the circumferential wall member 5 prevents the cleaning liquid LC that permeates the cleaning member 3 from leaking to the outer side of the base member 2. In other words, it stops the cleaning liquid LC that exudes from the cleaning member 3 from flowing to the outer side of the base member 2.

In the present embodiment, the circumferential wall member 5 recovers the cleaning liquid LC that exudes from the cleaning member 3.

In the present embodiment, the circumferential wall member 5 is a sponge. Accordingly, the circumferential wall member 5 is capable of absorbing and recovering the cleaning liquid LC that exudes from the cleaning member 3.

In the present embodiment, when the cleaning tool 1 is in its initial state, that is, before it performs the cleaning process on the member inside the exposure apparatus EX, the cleaning member 3 is permeated with the cleaning liquid LC and the circumferential wall member 5 is not permeated with liquid. Namely, when the cleaning tool 1 is in its initial state, the circumferential wall member 5 is in a dry state. Accordingly, the circumferential wall member 5 can satisfactorily absorb and recover any of the cleaning liquid LC that exudes from the cleaning member 3.

Furthermore, when the cleaning tool 1 is in its initial state, the circumferential wall member 5 may be slightly permeated with liquid.

A sponge made of polyvinyl alcohol (i.e., a PVA sponge), a sponge made of urethane (i.e., a urethane sponge), or the like can be used as the sponge that constitutes the circumferential wall member 5. Furthermore, the sponge's material in not limited to those materials mentioned above and may be any material provided it does not produce contaminants such as foreign matter.

The circumferential wall member 5 has a third height H3 with respect to the front surface 2A of the base member 2. The third height H3 is the distance between the front surface 2A of the base member 2 and an upper surface 4C of the circumferential wall member 5 in the Z axial directions (i.e., in the normal line directions of the front surface 2A of the base member 2). In the present embodiment, the upper surface 4C is substantially flat. In addition, the front surface 2A of the base member 2 and the upper surface 4C of the circumferential wall member 5 are substantially parallel.

In the present embodiment, the third height H3 is less than the first and second heights H1, H2. Namely, the circumferential wall member 5 is shorter than the cleaning member 3 (3A, 3B) with respect to the front surface 2A of the base member 2. The third height H3 is a height in the state wherein the circumferential wall member 5 is not compressed (i.e., the state wherein external forces are not applied).

The circumferential wall member 5 is lyophilic with respect to the cleaning liquid LC from the cleaning member 3. Thereby, it is possible to both satisfactorily recover (i.e., absorb) the cleaning liquid LC that exudes from the cleaning member 3 and prevent the cleaning liquid LC from leaking out. In addition, by making the circumferential wall member 5 lyophilic with respect to the cleaning liquid LC, the cleaning liquid LC can be satisfactorily recovered (i.e., absorbed) even when the volume or the third height H3 of the circumferential wall member 5 is small.

Furthermore, the entire circumferential wall member 5, or just a part thereof, may be made of sponge.

The following text explains one example of the exposure apparatus EX that comprises the member to be cleaned. FIG. 3 is a schematic block diagram that shows one example of the exposure apparatus EX according to the present embodiment. The present embodiment explains an exemplary case wherein the exposure apparatus EX is an immersion exposure apparatus that exposes the substrate P with the exposure light EL that passes through exposure liquid LQ.

In FIG. 3, the exposure apparatus EX comprises: a movable mask stage 11 that holds a mask M; a movable substrate stage 12 that holds the substrate P; an illumination system IL that illuminates the mask M with the exposure light EL; a projection optical system PL that projects an image of a pattern of the mask M, which is illuminated by the exposure light EL, to the substrate P; a liquid immersion member 13, which is capable of forming an immersion space LS such that at least part of the optical path K of the exposure light EL is filled with the first liquid LQ; a transport system 14, which is capable of transporting the substrate P; and a control apparatus 15 that controls the operation of the entire exposure apparatus EX.

The mask M may be, for example, a reticle wherein a device pattern projected onto the substrate P is formed. The mask M may be, for example, a transmissive mask wherein a light shielding film made of chrome and the like is used to form a prescribed pattern on a transparent plate, such as a glass plate. Furthermore, the mask M may alternatively be a reflective mask. The substrate P is a substrate for fabricating devices. The substrate P comprises a base material (e.g., a semiconductor wafer, such as a silicon wafer) and a photosensitive film that is formed thereon. The photosensitive film is made of a photosensitive material (e.g., photoresist). In addition, the substrate P may include a film other than the photosensitive film. For example, the substrate P may include an antireflection film or a protective film (i.e., a topcoat film) that protects the photosensitive film.

The illumination system IL illuminates a prescribed illumination region IR with the exposure light EL, which has a uniform luminous flux intensity distribution. The illumination system IL illuminates at least part of the mask M disposed in the illumination region IR with the exposure light EL, which has a uniform luminous flux intensity distribution. Examples of light that can be used as the exposure light EL emitted from the illumination system IL include: deep ultraviolet (DUV) light such as a bright line (g-line, h-line, or i-line) light emitted from, for example, a mercury lamp and KrF excimer laser light (with a wavelength of 248 nm); and vacuum ultraviolet (VUV) light such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

The mask stage 11 comprises a mask holding part 11H that releasably holds the mask M. In the present embodiment, the mask holding part 11H holds the mask M such that a patterned surface (i.e., a lower surface) of the mask M is substantially parallel to the XY plane. The mask stage 11, in the state wherein it holds the mask M, is capable of moving within the XY plane that includes the illumination region IR by the operation of a first drive system 11D that comprises actuators such as linear motors. In the present embodiment, in the state wherein the mask M is held by the mask holding part 11H, the mask stage 11 is capable of moving in three directions: the X axial, Y axial, and θZ directions.

Laser interferometers 16A of an interferometer system 16 measure the position of the mask stage 11 (i.e., the mask M). The laser interferometers 16A measure the position using reflecting mirrors 11R, which are provided to the mask stage 11. Based on the measurement results of the laser interferometers 16A, the control apparatus 15 controls the position of the mask M, which is held by the mask stage 11, by operating the first drive system 11D.

The projection optical system PL radiates the exposure light EL to a prescribed projection region PR. The projection optical system PL projects with a prescribed projection magnification an image of the pattern of the mask M to at least part of the substrate P, which is disposed in the projection region PR. A lens barrel 17 holds a plurality of optical elements of the projection optical system PL. The projection optical system PL of the present embodiment is a reduction system that has a projection magnification of, for example, ¼, ⅕, or ⅛. Furthermore, the projection optical system PL may also be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

The substrate stage 12 comprises a substrate holding part 12H, which releasably holds the substrate P. In the present embodiment, the substrate holding part 12H holds the substrate P such that the front surface (i.e., the exposure surface) of the substrate P is substantially parallel to the XY plane. The substrate stage 12, in the state wherein it holds the substrate P, is capable of moving, by the operation of a second drive system 12D that comprises actuators such as linear motors, along an upper surface 18G (i.e., a guide surface) of a base plate 18 within an XY plane that includes the projection region PR. In the present embodiment, in the state wherein the substrate P is held by the substrate holding part 12H, the substrate stage 12 is capable of moving in six directions: the X, Y, and Z axial directions, and the θX, θY, and θZ directions.

The substrate stage 12 has an upper surface 12T, which is disposed around the substrate holding part 12H. The substrate holding part 12H is disposed in a recessed part 12C, which is provided on the substrate stage 12. The upper surface 12T of the substrate stage 12 is flat and substantially parallel to the XY plane. The front surface of the substrate P, which is held by the substrate holding part 12H, and the upper surface 12T of the substrate stage 12 are disposed in substantially the same plane (i.e., they are substantially flush with one another).

Laser interferometers 16B of the interferometer system 16 measure the position of the substrate stage 12 (i.e., the substrate P) in the X axial, Y axial, and θZ directions. The laser interferometers 16B measure the position of the substrate stage 12 using reflecting mirrors 12R, which are provided to the substrate stage 12. In addition, a focus and level detection system (not shown) detects the position (in the Z axial, θX, and θY directions) of a front surface of the substrate P, which is held by the substrate stage 12. Based on the measurement results of the laser interferometers 16B and the detection results of the focus and level detection system, the control apparatus 15 controls the position of the substrate P held by the substrate stage 12 by operating the second drive system 12D.

The transport system 14 is capable of transporting the substrate P. In the present embodiment, the transport system 14 is capable of loading the unexposed substrate P onto the substrate holding part 12H and unloading the exposed substrate P from the substrate holding part 12H.

When the substrate P is loaded onto the substrate holding part 12H, the control apparatus 15 moves the substrate stage 12 to a substrate exchange position CP, which is different from an irradiation position EP of the exposure light EL that emerges from the projection optical system PL. In addition, when the substrate P is unloaded from the substrate holding part 12H, the control apparatus 15 moves the substrate stage 12 to the substrate exchange position CP.

The substrate stage 12 is capable of moving within a prescribed area of the guide surface 18G that includes the irradiation position EP of the exposure light EL and the substrate exchange position CP. The transport system 14 can perform both a loading operation, wherein the substrate P is loaded onto the substrate holding part 12H of the substrate stage 12, which has moved to the substrate exchange position CP, and an unloading operation, wherein the substrate P is unloaded from the substrate holding part 12H of the substrate stage 12. The control apparatus 15 is capable of performing a substrate exchange operation, which includes both the unloading operation that uses the transport system 14 to unload an exposed substrate P from the substrate stage 12 (i.e., the substrate holding part 12H), which has moved to the substrate exchange position CP, and the loading operation that loads the unexposed substrate P to be exposed next onto the substrate stage 12 (i.e., the substrate holding part 12H).

The liquid immersion member 13 is capable of forming the immersion space LS with the liquid LQ such that at least part of the optical path K of the exposure light EL is filled with the exposure liquid LQ. The immersion space LS is a space that is filled with the liquid LQ. In the present embodiment, water (i.e., pure water) is used as the liquid LQ.

In the present embodiment, the immersion space LS is formed such that an optical path K of the exposure light EL that emerges from a last optical element 19, which is the optical element of the plurality of optical elements of the projection optical system PL closest to the image plane thereof, is filled with the liquid LQ. The last optical element 19 has an emergent surface 20 that emits the exposure light EL toward the image plane of the projection optical system PL. The immersion space LS is formed such that the optical path K between the last optical element 19 and an object disposed at a position at which it opposes the emergent surface 20 of the last optical element 19 is filled with the liquid LQ. The position at which the object opposes the emergent surface 20 includes the irradiation position EP of the exposure light EL that emerges from the emergent surface 20.

The liquid immersion member 13 is disposed in the vicinity of the last optical element 19. The liquid immersion member 13 is capable of forming the immersion space LS such that the optical path K of the exposure light EL between the last optical element 19 and the object, which is disposed at the irradiation position EP of the exposure light EL that emerges from the emergent surface 20, is filled with the liquid LQ. The liquid immersion member 13 has a lower surface 21, which is disposed around the optical path K of the exposure light EL that emerges from the emergent surface 20, that is capable of holding the liquid LQ between itself and the front surface of the object disposed at the irradiation position EP of the exposure light EL. In the present embodiment, the object capable of opposing the emergent surface 20 is also capable of opposing the lower surface 21. When the front surface of the object is disposed at a position at which it opposes the emergent surface 20, at least part of the lower surface 21 and the front surface of the object are opposed. When the emergent surface 20 and the front surface of the object are opposed, the last optical element 19 is capable of holding the liquid LQ therebetween. In addition, when the lower surface 21 and the front surface of the object are opposed, the liquid immersion member 13 is capable of holding the liquid LQ therebetween. Holding the liquid LQ between the emergent surface 20 and the lower surface 21 on one side and the front surface of the object on the other side forms the immersion space LS such that the optical path K of the exposure light EL between the emergent surface 20 of the last optical element 19 and the front surface of the object is filled with the liquid LQ.

In the present embodiment, the object, which is capable of opposing the emergent surface 20 and the lower surface 21, may be an object that is capable of moving on the emergent side (i.e., the image plane side) of the last optical element 19 and an object that is capable of moving within a prescribed surface that includes the irradiation position EP of the exposure light EL. In the present embodiment, the object includes either the substrate stage 12 or the substrate P, which is held by the substrate stage 12, or both.

When the substrate P, which is held by the substrate stage 12, is to be exposed, the substrate P is disposed at the irradiation position EP of the exposure light EL such that it opposes the last optical element 19 and the liquid immersion member 13. The immersion space LS is formed, at least at the time the substrate P is to be exposed, by holding the liquid LQ between the last optical element 19 and the liquid immersion member 13 on one side and the substrate P on the other side such that the optical path K of the exposure light EL that emerges from the emergent surface 20 of the last optical element 19 is filled with the liquid LQ.

In the present embodiment, the immersion space LS is formed such that part of the area of the front surface of the substrate P that includes the projection region PR of the projection optical system PL is covered with the liquid LQ. An interface LG (i.e., a meniscus or an edge) of the liquid LQ is formed between the lower surface 21 of the liquid immersion member 13 and the front surface of the substrate P. Namely, the exposure apparatus EX of the present embodiment adopts a local liquid immersion system.

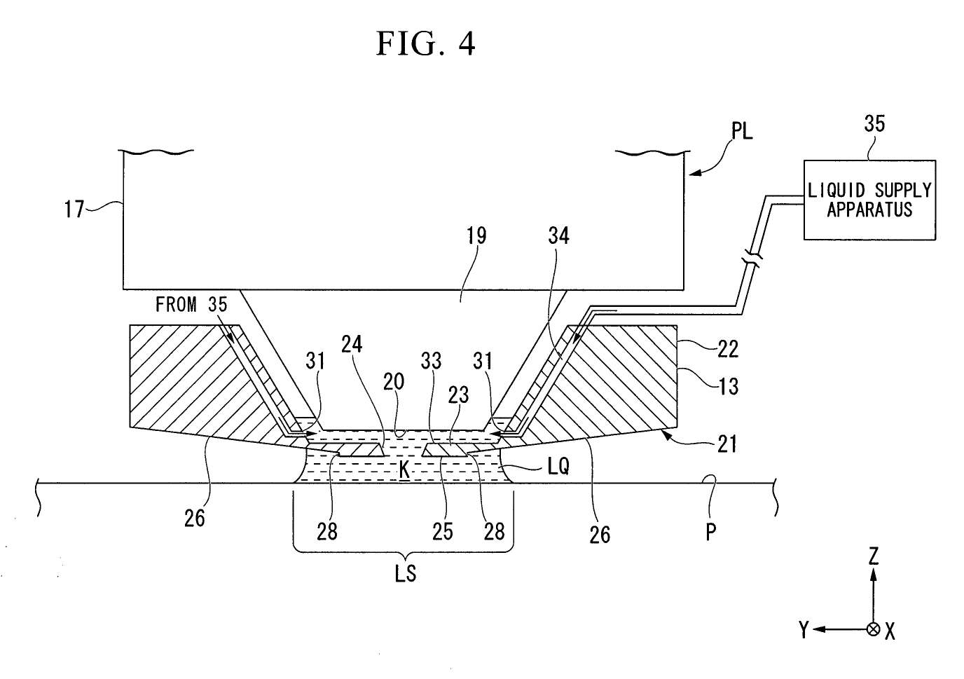

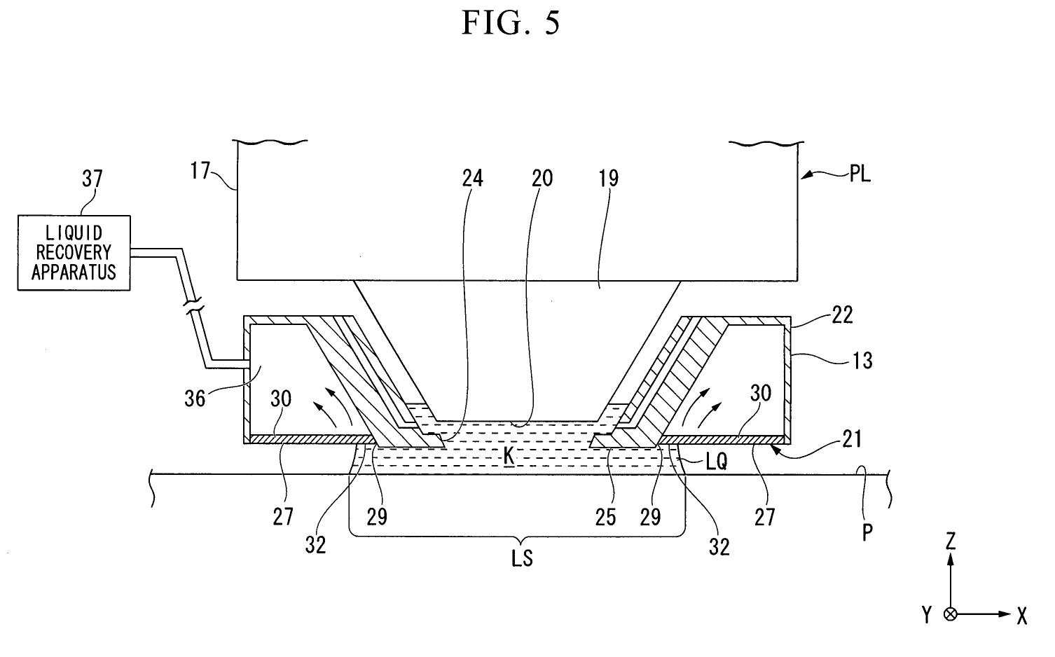

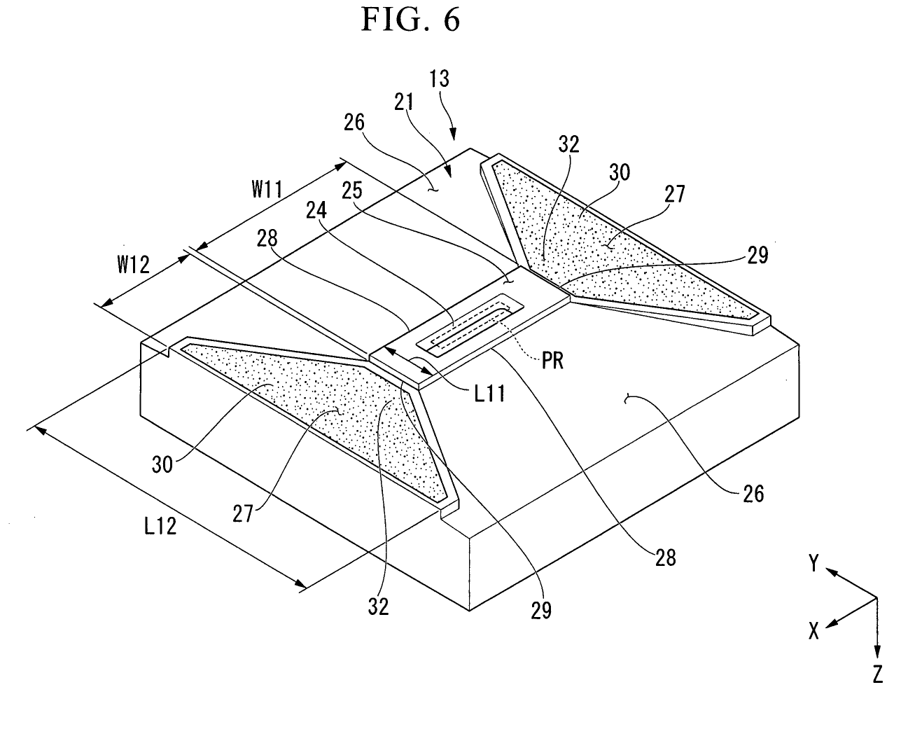

The following text explains the liquid immersion member 13, referencing FIG. 4 through FIG. 6. FIG. 4 is a side cross sectional view parallel to the YZ plane that shows the vicinity of the liquid immersion member 13; FIG. 5 is a side cross sectional view parallel to the XZ plane; and FIG. 6 is an oblique view from the lower side (i.e., the −Z side) that shows the liquid immersion member 13.

Furthermore, the following text principally explains an exemplary state wherein the substrate P is disposed at a position at which it opposes both the emergent surface 20 of the last optical element 19 and the lower surface 21 of the liquid immersion member 13; however, as discussed above, it is also possible to dispose an object other than the substrate P, such as the substrate stage 12, at a position at which it opposes both the emergent surface 20 of the last optical element 19 and the lower surface 21 of the liquid immersion member 13.

The liquid immersion member 13 is a ring shaped member and is disposed around the optical path K of the exposure light EL. In the present embodiment, the liquid immersion member 13 comprises an upper plate part 22, which is disposed around the last optical element 19, and a lower plate part 23, at least part of which is disposed between the emergent surface 20 of the last optical element 19 and the front surface of the substrate P in the Z axial directions.

The upper plate part 22 has an inner circumferential surface that opposes and is formed along an outer circumferential surface of the last optical element 19. The inner circumferential surface of the upper plate part 22 and the outer circumferential surface of the last optical element 19 oppose one another with a prescribed gap interposed therebetween.

The lower plate part 23 has an opening 24 at its center. The exposure light EL that emerges from the emergent surface 20 of the last optical element 19 can pass through the opening 24. For example, during an exposure of the substrate P, the exposure light EL that emerges from the emergent surface 20 passes through the opening 24 and is radiated through the liquid LQ to the front surface of the substrate P. In the present embodiment, the cross sectional shape of the exposure light EL in the opening 24 is substantially rectangular (i.e., slit shaped) with the longitudinal directions in the X axial directions. In accordance with the cross sectional shape of the exposure light EL, the opening 24 is formed in a substantially rectangular shape (i.e., a slit shape) in the X and Y directions. In addition, the cross sectional shape of the exposure light EL in the opening 24 and the shape of the projection region PR of the projection optical system PL on the substrate P are substantially the same.

In the present embodiment, the liquid immersion member 13 has an upper surface 33 that is disposed around the optical path K and opposes the emergent surface 20 of the last optical element 19 with a prescribed gap interposed therebetween. In the present embodiment, the upper surface 33 includes the upper surface of the lower plate part 23. The upper surface 33 is flat and is substantially parallel to the XY plane. The upper surface 33 is disposed around the opening 24.

The lower surface 21 of the liquid immersion member 13 includes: a first surface 25, which is disposed around the optical path K of the exposure light EL; second surfaces 26, which are disposed partly around the first surface 25; and third surfaces 27, which are also disposed partly around the first surface 25.

During the exposure of the substrate P, the first surface 25 holds the liquid LQ between itself and the substrate P. In the present embodiment, the first surface 25 is flat and substantially parallel to the front surface of the substrate P (i.e., the XY plane). In the present embodiment, the first surface 25 has a rectangular external shape within the XY plane. The first surface 25 has an external shape that is long in the X axial directions, a size W11 in the X axial directions, and a size L11 in the Y axial directions.

In the present embodiment, the first surface 25 includes the lower surface of the lower plate part 23. The first surface 25 is disposed around the opening 24. The first surface 25 is not capable of recovering the liquid LQ.

The second surfaces 26 are disposed on the outer sides of the first surface 25 with respect to the optical path K of the exposure light EL. The second surfaces 26 are disposed on opposite sides of the optical path K of the exposure light EL in the Y axial directions. In the present embodiment, one of the second surfaces 26 is provided in one of the Y axial directions (i.e., on the +Y side) and the other second surface 26 is provided in the other Y axial direction (i.e., on the −Y side) with respect to the first surface 25.

During the exposure of the substrate P, each of the second surfaces 26 is capable of holding the liquid LQ between itself and the front surface of the substrate P. The second surfaces 26 are disposed at positions at which they are farther from the front surface of the substrate P than the first surface 25 is. The second surfaces 26 are inclined in the Y axial directions such that they become gradually spaced apart from the front surface of the substrate P in the directions (i.e., the radial directions) that lead away from the optical path K of the exposure light EL. The second surfaces 26 are not capable of recovering the liquid LQ.

In the present embodiment, the −Y side edge of the second surface 26 that is disposed on the +Y side of the optical path K of the exposure light EL and the +Y side edge of the first surface 25 are disposed at different positions (i.e., heights) in the Z axial directions. In addition, the +Y side edge of the second surface 26 that is disposed on the −Y side of the optical path K of the exposure light EL and the −Y side edge of the first surface 25 are disposed at different positions (i.e., heights) in the Z axial directions. In the present embodiment, steps 28 are formed between the first surface 25 and the second surfaces 26.

In addition, in the present embodiment, the external shape of the second surfaces 26 within the XY plane is trapezoidal, wherein the portions adjacent to the +Y side and −Y side edges of the first surface 25 are the upper sides.

The third surfaces 27 are disposed on the outer sides of the first surface 25 with respect to the optical path K of the exposure light EL. The third surfaces 27 are disposed on opposite sides of the optical path K of the exposure light EL in the X axial directions. In the present embodiment, one of the third surfaces 27 is provided in one of the X axial directions (i.e., on the +X side) and the other third surface 27 is provided in the other X axial direction (i.e., on the −X side) with respect to the first surface 25.

Each of the third surfaces 27 includes a liquid recovery surface that is capable of recovering the liquid LQ. The third surfaces 27 are substantially parallel to the front surface of the substrate P (i.e., the XY plane). During the exposure of the substrate P, the third surfaces 27 are capable of recovering the liquid LQ on the substrate P that opposes the third surfaces 27. In the present embodiment, the third surfaces 27 include the front surfaces (i.e., the lower surfaces) of porous members 30. At least some of the liquid LQ on the substrate P, which is disposed at a position at which it opposes the third surfaces 27, is recovered via holes of the porous members 30. The third surfaces 27 (i.e., the front surfaces of the porous members 30) are capable of recovering the liquid LQ that contacts them.

In the present embodiment, the position of the first surface 25 and the positions of the third surfaces 27 in the Z axial directions are different. In the present embodiment, the −X side edge of the third surface 27 that is disposed on the +X side of the optical path K of the exposure light EL and the +X side edge of the first surface 25 are disposed at different positions (i.e., heights) in the Z axial directions. In addition, the +X side edge of the third surface 27 that is disposed on the −X side of the optical path K of the exposure light EL and the −X side edge of the first surface 25 are disposed at different positions (i.e., heights) in the Z axial directions.

In the present embodiment, the third surfaces 27 are disposed on the +Z side of the first surface 25. Namely, the third surfaces 27 are disposed at positions at which they are farther from the front surface of the substrate P than the first surface 25 is. In the present embodiment, steps 29 are formed between the first surface 25 and the third surfaces 27.

In addition, in the present embodiment, the external shape of the third surfaces 27 within the XY plane is trapezoidal, wherein the portions adjacent to the +X side and the −X side edges of the first surface 25 are the upper sides. Each of the third surfaces 27 has a size W12 in the X axial directions and a size L12 in the Y axial directions.

The liquid immersion member 13 has liquid supply ports 31 that supply the liquid LQ and liquid recovery ports 32 that recover the liquid LQ. To form the immersion space LS, the liquid supply ports 31 supply the liquid LQ toward the optical path K. The liquid recovery ports 32 recover at least some of the liquid LQ on the substrate P that opposes the lower surface 21 of the liquid immersion member 13.

The liquid supply ports 31 are disposed at prescribed positions of the liquid immersion member 13 in the vicinity of the optical path K such that they face the optical path K. In the present embodiment, the liquid supply ports 31 are disposed in the vicinity of the space between the emergent surface 20 and the upper surface 33.

The liquid supply ports 31 are connected to a liquid supply apparatus 35 via passageways 34. The liquid supply apparatus 35 is capable of delivering the liquid LQ, which is pure and temperature adjusted. Each passageway 34 comprises a supply passageway, which is formed inside the liquid immersion member 13, and a passageway, which is formed from a supply pipe that connects the supply passageway and the liquid supply apparatus 35. The liquid LQ that is delivered from the liquid supply apparatus 35 is supplied to each of the liquid supply ports 31 through the corresponding passageway 34. The liquid supply ports 31 supply the liquid LQ from the liquid supply apparatus 35 to the optical path K.

Each of the liquid recovery ports 32 is disposed at a prescribed position in the liquid immersion member 13 such that it opposes the front surface of the substrate P. The liquid recovery ports 32 are disposed on the outer sides of the first surface 25 with respect to the optical path K. The liquid recovery ports 32 are disposed on opposite sides of the optical path K with respect to the X axial directions. Each of the plate shaped porous members 30, which has a plurality of holes (i.e., openings or pores), is disposed in the corresponding liquid recovery port 32. Namely, in the present embodiment, each of the third surfaces 27 (i.e., the liquid recovery surfaces) includes the front surface (i.e., lower surface) of the porous member 30 disposed in the corresponding liquid recovery port 32. Furthermore, a mesh filter, which is a porous member wherein numerous small holes are formed as a mesh, may be disposed in each of the liquid recovery ports 32.

The liquid recovery ports 32 (i.e., the third surfaces 27) are connected to a liquid recovery apparatus 37 via a passageway 36. The liquid recovery apparatus 37 comprises a vacuum system and is capable of recovering the liquid LQ via suctioning. The passageway 36 comprises a recovery passageway, which is formed inside the liquid immersion member 13, and a passageway, which is formed from a recovery pipe that connects the recovery passageway and the liquid recovery apparatus 37. The liquid LQ recovered via the liquid recovery ports 32 (i.e., the third surfaces 27) is recovered by the liquid recovery apparatus 37 through the passageway 36.

In the present embodiment, the control apparatus 15 is capable of forming the immersion space LS with the liquid LQ between the last optical element 19 and the liquid immersion member 13 on the one side and the substrate P (i.e., the object) on the other side by performing a recovery operation, wherein the liquid recovery ports 32 are used to recover the liquid LQ, in parallel with a supply operation, wherein the liquid supply ports 31 are used to supply the liquid LQ.

When the substrate P is disposed at a position at which it opposes the lower surface 21, the liquid immersion member 13 can hold the liquid LQ at least between the front surface of the substrate P and the first surface 25. In the present embodiment, at least the first surface 25 of the liquid immersion member 13 is lyophilic with respect to the liquid LQ, and therefore the first surface 25 can maintain contact with the liquid LQ of the immersion space LS even if the substrate P is moved in the X and Y directions.

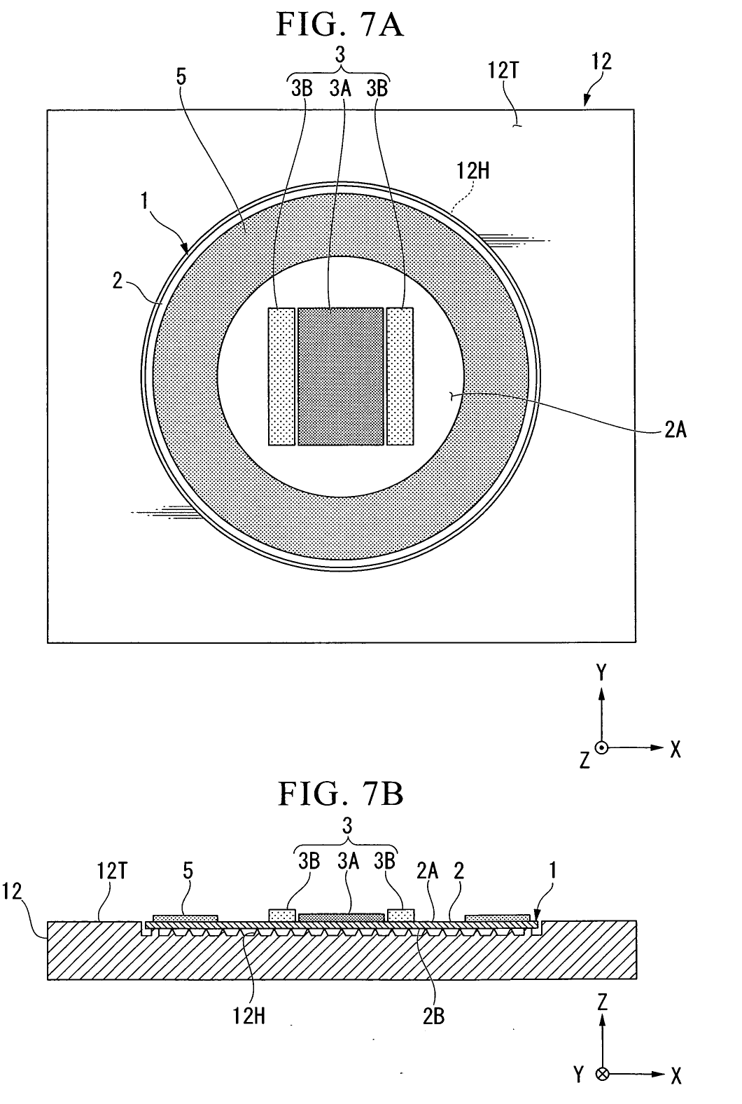

FIG. 7A is a plan view that shows the state wherein the cleaning tool 1 is held by the substrate holding part 12H, and FIG. 7B is a side cross sectional view thereof. As discussed above, the external shape of the base member 2 of the cleaning tool 1 is substantially the same as that of the substrate P. As shown in FIGS. 7A and 7B, the substrate holding part 12H is capable of holding the rear surface 2B of the base member 2. The substrate holding part 12H releasably holds the cleaning tool 1 (i.e., the base member 2).

In addition, in the present embodiment, the transport system 14 is capable of transporting the cleaning tool 1. The transport system 14 is capable of loading the cleaning tool 1 onto the substrate holding part 12H and unloading the cleaning tool 1 from the substrate holding part 12H.

When the cleaning tool 1 is loaded onto the substrate holding part 12H, the control apparatus 15 moves the substrate stage 12 to the substrate exchange position CP. In addition, when the cleaning tool 1 is unloaded from the substrate holding part 12H, the control apparatus 15 moves the substrate stage 12 to the substrate exchange position CP.

The following text explains one example of a method of using the exposure apparatus EX discussed above to expose the substrate P. Where appropriate in the explanation below, the irradiation position EP of the exposure light EL that emerges from the emergent surface 20 of the last optical element 19 is called the exposure position EP.

The control apparatus 15 moves the substrate stage 12 to the substrate exchange position CP and uses the transport system 14 to load the unexposed substrate P onto the substrate stage 12, which is disposed at the substrate exchange position CP. The control apparatus 15 moves the substrate stage 12, which holds the unexposed substrate P, to the exposure position EP.

The control apparatus 15 forms the immersion space LS such that the optical path K between the last optical element 19 and the liquid immersion member 13 on one side and the substrate P, which is held by the substrate stage 12 that moved to the exposure position EP, on the other side is filled with the liquid LQ.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. When the substrate P is to be exposed, the control apparatus 15 controls the mask stage 11 and the substrate stage 12 to move the mask M and the substrate P, respectively, in the prescribed scanning directions within the XY plane, which is orthogonal to the optical axis AX (i.e., the optical path K of the exposure light EL). In the present embodiment, the scanning directions (i.e., the synchronous movement directions) of both the substrate P and the mask M are the Y axial directions. The control apparatus 15 moves the substrate P in one of the Y axial directions with respect to the projection region PR of the projection optical system PL and radiates the exposure light EL to the substrate P through the projection optical system PL and the liquid LQ in the immersion space LS on the substrate P while moving the mask M, synchronized to the movement of the substrate P, in the other Y axial direction with respect to the illumination region IR of the illumination system IL. Thereby, the image of the pattern of the mask M is projected to the substrate P, which is thereby exposed by the exposure light EL.

The exposed substrate P is then unloaded from the substrate stage 12. To unload the exposed substrate P from the substrate stage 12, the control apparatus 15 moves the substrate stage 12 to the substrate exchange position CP. The control apparatus 15 uses the transport system 14 to unload the exposed substrate P from the substrate stage 12, which is disposed at the substrate exchange position CP.

The control apparatus 15 successively performs immersion exposures on a plurality of substrates P by repetitively performing the loading operation, which loads an unexposed substrate P, the exposure operation, which exposes the substrate P, and the unloading operation, which unloads the exposed substrate P.

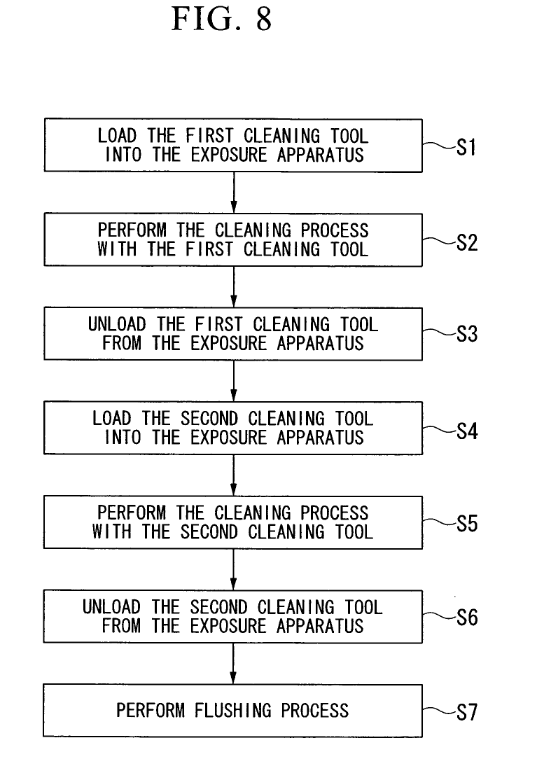

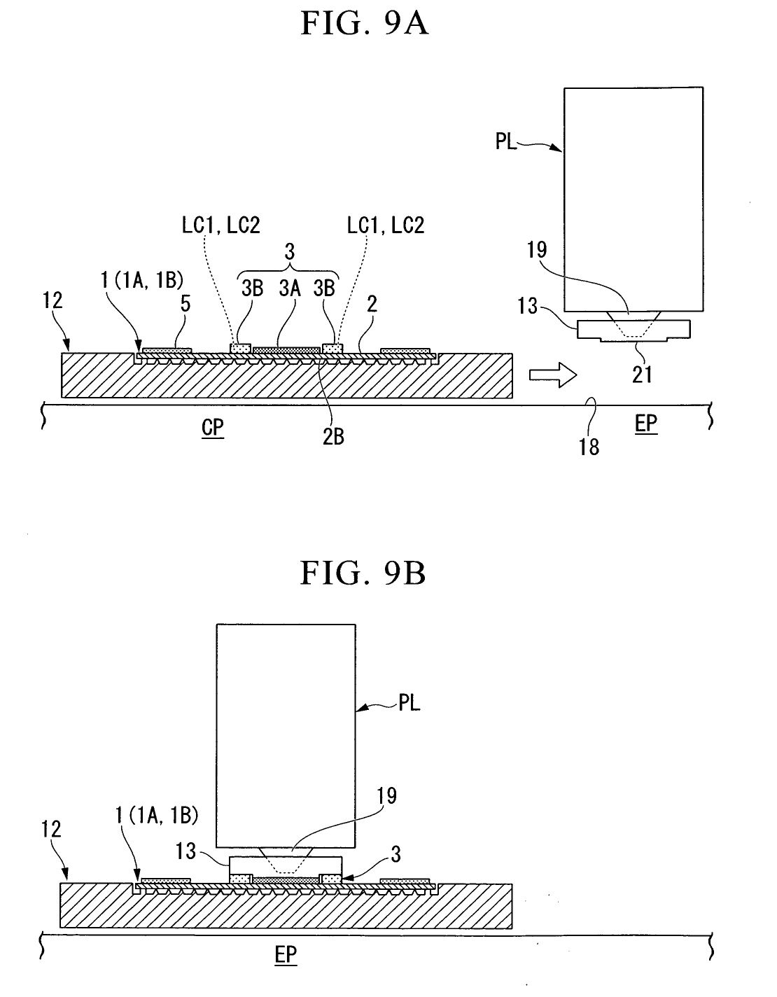

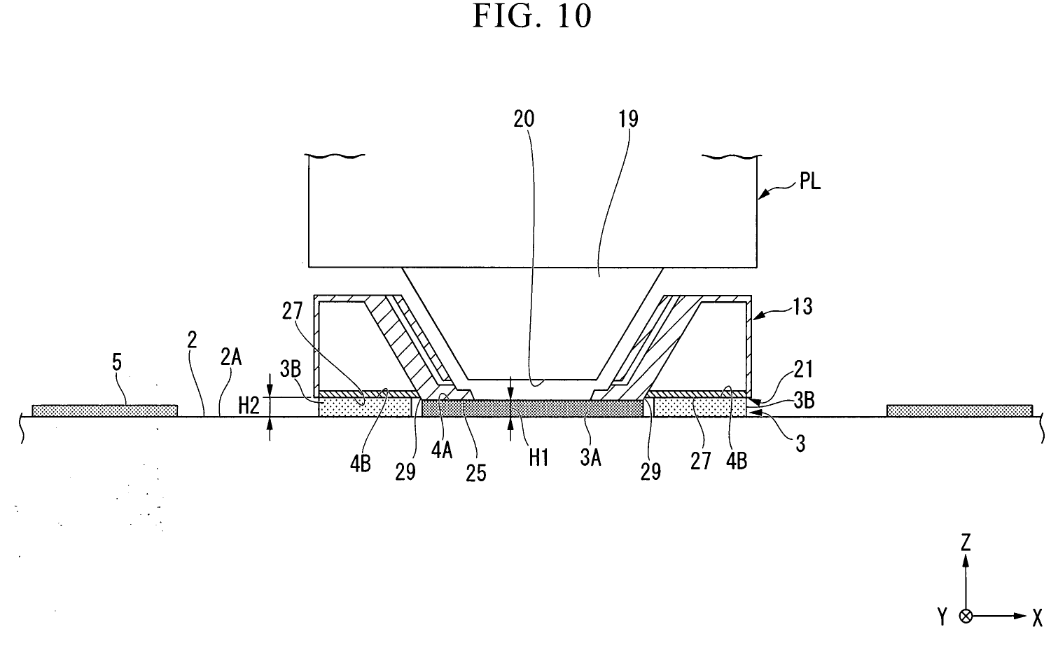

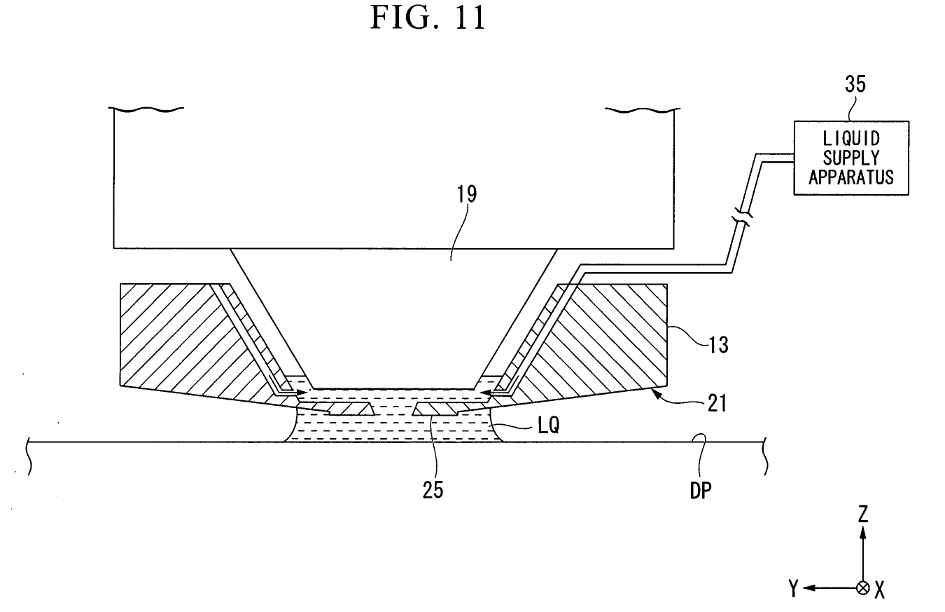

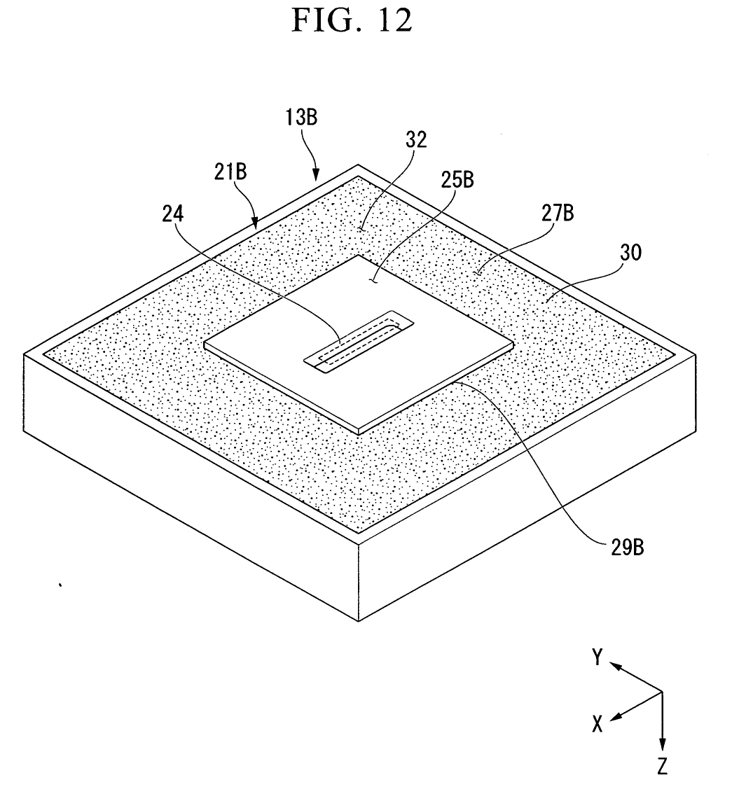

In the present embodiment, a cleaning process, which cleans the member inside the exposure apparatus EX using the cleaning tool 1 discussed above, is performed with a prescribed timing. The following text explains a method of cleaning the member inside the exposure apparatus EX using the cleaning tool 1, referencing the flow chart in FIG. 8 and the schematic drawings in FIG. 9A, FIG. 9B, FIG. 10, and FIG. 11. The present embodiment explains an exemplary case wherein the lower surface 21 of the liquid immersion member 13 is cleaned using the cleaning tool 1.

In the present embodiment, when the cleaning process is to be performed on the liquid immersion member 13 using the cleaning tool 1, the formation of the immersion space LS is cancelled. Namely, when the cleaning process is performed, the liquid LQ is removed from the lower surface 21 side of the liquid immersion member 13. In addition, the liquid LQ is also removed from the liquid supply ports 31 of the liquid immersion member 13 and the supply passageway as well as the liquid recovery ports 32 of the liquid immersion member 13 and the recovery passageway.

As shown in FIG. 8, the present embodiment comprises: a process that loads a first cleaning tool 1A, which comprises the cleaning member 3 permeated with a first cleaning liquid LC1, into the exposure apparatus EX (step S1); a process that brings the lower surface 21 of the liquid immersion member 13 and the cleaning member 3 of the first cleaning tool 1A permeated with the first cleaning liquid LC1 into contact with one another and cleans the lower surface 21 of the liquid immersion member 13 (step S2); a process that, after the performance of the cleaning process wherein the first cleaning tool 1A is used, unloads the first cleaning tool 1A from the exposure apparatus EX (step S3); a process that loads a second cleaning tool 1B, which comprises the cleaning member 3 permeated with a second cleaning liquid LC2 that is different from the first cleaning liquid LC1, into the exposure apparatus EX (step S4); a process that brings the lower surface 21 of the liquid immersion member 13 and the cleaning member 3 of the second cleaning tool 1B permeated with the second cleaning liquid LC2 into contact with one another and cleans the lower surface 21 of the liquid immersion member 13 (step S5); a process that, after the performance of the cleaning process wherein the second cleaning tool 1B is used, unloads the second cleaning tool 1B from the exposure apparatus EX (step S6); and a flushing process that, after the performance of the cleaning process wherein the first and second cleaning tools 1A, 1B are used and before the exposure of the substrate P, supplies the liquid LQ to eliminate either or both of the cleaning liquids from the liquid immersion member 13 (step S7).

To clean the liquid immersion member 13, the first cleaning tool 1A is loaded into the exposure apparatus EX. The cleaning member 3 of the first cleaning tool 1A is permeated with the first cleaning liquid LC1 before the cleaning process is performed. In the present embodiment, the first cleaning liquid LC1 is an alkali cleaning liquid that contains alkali. Moreover, the circumferential wall member 5 is in a dry state.

In the present embodiment, the transport system 14 and the substrate stage 12 loads the first cleaning tool 1A to a position at which it opposes the liquid immersion member 13. In the present embodiment, the transport system 14 loads the first cleaning tool 1A onto the substrate stage 12, which moves the first cleaning tool 1A to a position at which it opposes the liquid immersion member 13.

FIGS. 9A and 9B are schematic drawings that shows one example of an operation that loads the first cleaning tool 1A and moves it to the position at which it opposes the liquid immersion member 13. As shown in FIG. 9A, the first cleaning tool 1A is loaded onto the substrate holding part 12H of the substrate stage 12, which is disposed at the substrate exchange position CP. In the present embodiment, the control apparatus 15 moves the substrate stage 12 to the substrate exchange position CP and uses the transport system 14 to load the first cleaning tool 1A onto the substrate stage 12 (i.e., the substrate holding part 12H), which is disposed at the substrate exchange position CP. The substrate holding part 12H holds the rear surface 2B of the base member 2 of the loaded first cleaning tool 1A.

Next, as shown in FIG. 9B, the control apparatus 15 moves the substrate stage 12, which holds the first cleaning tool 1A, such that the first cleaning tool 1A is disposed at a position (i.e., the exposure position EP) at which it opposes the liquid immersion member 13 (step S1).

Furthermore, the position (i.e., the height) of the substrate stage 12 in the Z axial directions when the substrate stage 12 is moved from the substrate exchange position CP to the exposure position EP in the state wherein it holds the first cleaning tool 1A can be made lower than the position (i.e., the height) of the substrate stage 12 in the Z axial directions when the substrate stage 12 is moved from the substrate exchange position CP to the exposure position EP in the state wherein it holds the substrate P in order to expose such. Thereby, when the substrate stage 12 is moved (i.e., advanced) from the substrate exchange position CP to the exposure position EP, the cleaning member 3 and the circumferential wall member 5 on the base member 2 are prevented from contacting the liquid immersion member 13.

In addition, the movement velocity (i.e., the advance velocity) of the substrate stage 12 when the substrate stage 12 is moved from the substrate exchange position CP to the exposure position EP in the state wherein it holds the first cleaning tool 1A may be set lower than the movement velocity (i.e., advance velocity) of the substrate stage 12 when the substrate stage 12 is moved from the substrate exchange position CP to the exposure position EP in the state wherein it holds the substrate P in order to expose such.

Next, the control apparatus 15 adjusts the positional relationship between the liquid immersion member 13 and the first cleaning tool 1A held by the substrate holding part 12H by moving the substrate stage 12 in the Z axial directions and thereby brings the lower surface 21 of the liquid immersion member 13 and the cleaning member 3 that is permeated with the first cleaning liquid LC1 of the first cleaning tool 1A into contact with one another (step S2). Thereby, the lower surface 21 of the liquid immersion member 13 is cleaned by the first cleaning tool 1A.

FIG. 10 shows the state wherein the cleaning member 3 and the lower surface 21 of the liquid immersion member 13 are in contact with one another. In the present embodiment, the first and second heights H1, H2 of the first and second cleaning members 3A, 3B are prescribed in accordance with the shape of the lower surface 21 of the liquid immersion member 13. As discussed above, in the present embodiment, the lower surface 21 of the liquid immersion member 13 includes the first surface 25 and the third surfaces 27, the positions of which are different in the Z axial directions. In the present embodiment, the first and second heights H1, H2 are prescribed such that the upper surface 4A of the first cleaning member 3A contacts the first surface 25 and the upper surfaces 4B of the second cleaning members 3B contact the third surfaces 27 in the state wherein the first and second cleaning members 3A, 3B, which are made of sponge, are not compressed. Thereby, the first cleaning member 3A satisfactorily cleans the first surface 25 and the second cleaning members 3B satisfactorily clean the third surfaces 27.

In the present embodiment, the control apparatus 15 adjusts the position of the substrate stage 12 in the Z axial directions such that the upper surfaces 4A, 4B of the first and second cleaning members 3A, 3B press against the first and third surfaces 25, 27 with a prescribed force. Thereby, the first and second cleaning members 3A, 3B, which are made of sponge, are slightly compressed; furthermore, the upper surfaces 4A, 4B of the first and second cleaning members 3A, 3B sufficiently contact the first and third surfaces 25, 27. Accordingly, the first and third surfaces 25, 27 can be cleaned satisfactorily using the first and second cleaning members 3A, 3B.

In the present embodiment, after bringing the upper surfaces 4A, 4B of the first and second cleaning members 3A, 3B and the first and third surfaces 25, 27 into contact with one another, the control apparatus 15 cleans the first and third surfaces 25, 27 of the liquid immersion member 13 in the state wherein the first and second cleaning members 3A, 3B are substantially stationary. Namely, after the upper surfaces 4A, 4B of the first and second cleaning members 3A, 3B and the first and third surfaces 25, 27 have been brought into contact with one another, the control apparatus 15 fixes the positional relationship between the first and second cleaning members 3A, 3B and the first and third surfaces 25, 27 of the liquid immersion member 13 for a prescribed time.

In the present embodiment, the size W1 of the first cleaning member 3A is substantially the same in the X axial directions as the size W11 of the first surface 25. In addition, the size L1 of the first cleaning member 3A is sufficiently larger in the Y axial directions than the size L11 of the first surface 25. Thereby, the entire area of the first surface 25 and the upper surface 4A of the first cleaning member 3A can be brought into contact with one another. Accordingly, the first cleaning member 3A can satisfactorily clean the first surface 25.

In addition, in the present embodiment, the size W2 of the second cleaning members 3B is substantially the same in the X axial directions as the size W12 of the third surfaces 27. In addition, the size L2 of the second cleaning members 3B is substantially the same in the Y axial directions as the size L12 of the third surfaces 27. Thereby, the entire area of the third surfaces 27 and the upper surfaces 4B of the second cleaning members 3B can be brought into contact with one another. Accordingly, the second cleaning members 3B can satisfactorily clean the third surfaces 27.

In addition, in the present embodiment, the circumferential wall member 5 is disposed on the base member 2, and thereby the cleaning liquid LC is prevented from leaking out during both the transport of the first cleaning tool 1A and the performance of the cleaning process. In addition, the circumferential wall member 5 is a sponge, and therefore the cleaning liquid LC that exudes from the cleaning member 3 during both the transport of the first cleaning tool 1A and the performance of the cleaning process can be recovered (i.e., absorbed).

After the cleaning process that uses the first cleaning tool 1A has ended, the control apparatus 15 moves the substrate stage 12, which holds the first cleaning tool 1A, to the substrate exchange position CP in order to unload the first cleaning tool 1A from the exposure apparatus EX. Furthermore, the control apparatus 15 uses the transport system 14 to unload the first cleaning tool 1A from the substrate stage 12, which is disposed at the substrate exchange position CP. Thereby, the first cleaning tool 1A is unloaded from the exposure apparatus EX (step S3).

After the first cleaning tool 1A has been unloaded from the exposure apparatus EX, the second cleaning tool 1B is loaded into the exposure apparatus EX. The cleaning 3 of the second cleaning tool 1B is permeated with the second cleaning liquid LC2 before the performance of the cleaning process. In the present embodiment, the second cleaning liquid LC2 is water (i.e., pure water). The circumferential wall member 5 is in a dry state.

The structure, the size, and the like of the first cleaning tool 1A and the second cleaning tool 1B are the same; they differ only in the type of cleaning liquid that permeates the cleaning member 3.

The control apparatus 15 uses the transport system 14 to load the second cleaning tool 1B onto the substrate stage 12 and moves the substrate stage 12 such that the second cleaning tool 1B is disposed at a position at which it opposes the liquid immersion member 13 (step S4). The operation of disposing the second cleaning tool 1B at a position at which it opposes the liquid immersion member 13 is substantially the same as the operation of disposing the first cleaning tool 1A at a position at which it opposes the liquid immersion member 13 (step S1), and consequently the explanation thereof is omitted.

Next, the control apparatus 15 adjusts the positional relationship between the liquid immersion member 13 and the second cleaning tool 1B held by the substrate holding part 12H by moving the substrate stage 12 in the Z axial directions, and thereby brings the lower surface 21 of the liquid immersion member 13 and the cleaning member 3 permeated with the second cleaning liquid LC2 of the second cleaning tool 1B into contact with one another (step S5). Thereby, the second cleaning tool 1B cleans the lower surface 21 of the liquid immersion member 13.

In the cleaning process that uses the second cleaning tool 1B, the control apparatus 15 cleans the liquid immersion member 13 in the state wherein the cleaning member 3 of the second cleaning tool 1B is substantially stationary. The operation performed during the cleaning process that uses the second cleaning tool 1B is substantially the same as the operation performed during the cleaning process that uses the first cleaning tool 1A (step S2), and consequently the explanation thereof is omitted.

After the cleaning process that uses the second cleaning tool 1B has ended, the control apparatus 15 moves the substrate stage 12 that holds the second cleaning tool 1B to the substrate exchange position CP to unload the second cleaning tool 1B from the exposure apparatus EX. Furthermore, the control apparatus 15 uses the transport system 14 to unload the second cleaning tool 1B from the substrate stage 12, which is disposed at the substrate exchange position CP. Thereby, the second cleaning tool 1B is unloaded from the exposure apparatus EX (step S6).

After the performance of the cleaning process that uses the first and second cleaning tools 1A, 1B and before the exposure of the substrate P using the liquid LQ, the control apparatus 15 performs the flushing process, which supplies the liquid LQ via the liquid supply ports 31, to remove the cleaning liquid LC from the lower surface 21 of the liquid immersion member 13 (step S7).

FIG. 11 shows the state wherein the flushing process is being performed using the liquid LQ. In the present embodiment, when the flushing process is performed, the substrate holding part 12H holds a dummy substrate DP. The dummy substrate DP is a member (i.e., a clean member) that is distinct from the substrate P used for exposure and has a high cleanliness level that tends not to release foreign matter. The external shape of the dummy substrate DP is substantially the same as that of the substrate P, and the substrate holding part 12H is capable of holding the dummy substrate. Instead of forming a photosensitive film and the like on a base material of, for example, a semiconductor wafer such as a silicon wafer, a protective film (i.e., a topcoat film) that is liquid repellent with respect to the liquid LQ can be formed thereon and the substrate can be used as the dummy substrate DP.

In the state wherein the dummy substrate DP, which is held by the substrate holding part 12H, is disposed at a position at which it opposes the last optical element 19 and the liquid immersion member 13, the control apparatus 15 performs the recovery operation, which recovers the liquid LQ using the liquid recovery ports 32, in parallel with the supply operation, which supplies the liquid LQ using the liquid supply ports 31. Thereby, the cleaning liquid LC that remains on, for example, the lower surface 21 of the liquid immersion member 13 and the porous members 30 and in, for example, the supply passageways 34 and the recovery passageway 36 is washed away. In the present embodiment, the first cleaning liquid LC1 (i.e., the alkali cleaning liquid) and the exposure liquid LQ (i.e., pure water) are different types of liquids. By using the exposure liquid LQ to remove the cleaning liquid LC prior to the exposure of the substrate P, the cleaning liquid LC is prevented from intermixing with the liquid LQ that fills the optical path K during subsequent exposures of substrates P.

After the processes of the steps S1-S7 discussed above, which include the cleaning process using the cleaning tool 1, have ended, the substrate P is held by the substrate holding part 12H and undergoes the exposing process. Prescribed processes, such as a developing process, are then performed on the exposed substrate P.

According to the present embodiment as explained above, it is possible to efficiently and satisfactorily clean the liquid immersion member 13 inside the exposure apparatus EX using the cleaning tool 1. Accordingly, it is possible to prevent the occurrence of exposure failures caused by the contamination of the liquid immersion member 13 and thereby to prevent the production of defective devices.

During, for example, the exposure of the substrate P, a substance (e.g., the photosensitive material) produced (i.e., eluted) from the substrate P might intermix with the liquid LQ. The substance that intermixes with the liquid LQ might adhere as foreign matter (i.e., contaminants) to the lower surface 21 of the liquid immersion member 13. In addition, along with the substance produced by the substrate P, foreign matter suspended in midair and the like might intermix with the first liquid LQ and adhere to the lower surface 21 of the liquid immersion member 13. The first surface 25, in particular, is in continuous contact with the liquid LQ during the exposure of the substrate P, and therefore there is a strong possibility that the first surface 25 will become contaminated. In addition, the third surfaces 27, which continuously recover the liquid LQ during the exposure of the substrate P, also continuously contact the liquid LQ, and therefore there is a strong possibility that the third surfaces 27 will become contaminated. If the foreign matter (i.e., the contaminants) is left in a state wherein it adheres to the lower surface 21 of the liquid immersion member 13, then that foreign matter might likewise adhere to the substrate P during an exposure or contaminate the liquid LQ supplied via the liquid supply ports 31. As a result, exposure failures such as, for example, the generation of defects in the pattern formed on the substrate P might occur.

In the present embodiment, the lower surface 21 of the liquid immersion member 13 can be cleaned satisfactorily using the cleaning tool 1. Accordingly, it is possible to prevent exposure failures from occurring in substrates P that are exposed after the cleaning process has been performed.

Furthermore, in the cleaning process of the present embodiment, the distance between the front surface 2A of the base material 2 and the liquid immersion member 13 may be set so that it is small, and the first cleaning member 3A and the second surfaces 26 of the liquid immersion member 13 may contact one another. In this case, the first cleaning member 3A may be inclined, in accordance with the inclination of the second surfaces 26, such that the front surface of the first cleaning member 3A gradually becomes higher as it passes from the center to the edge of the first cleaning member 3A in the Y axial directions. Naturally, to clean the second surfaces 26, cleaning members that are different from the first cleaning member 3A may be provided on opposite sides thereof in the Y axial directions. In other words, the layout and size of the cleaning members in the XY plane, as well as the height of the cleaning members, should be determined in accordance with the profile (shape) and size of the lower surface 21 of the liquid immersion member 13.

### Second Embodiment

The following text explains a second embodiment. In the explanation below, constituent parts that are identical or equivalent to those in the embodiment discussed above are assigned identical symbols, and the explanations thereof are therefore abbreviated or omitted.

FIG. 12 is an oblique view from the lower side (i.e., −Z side) that shows a liquid immersion member 13B according to a second embodiment. In FIG. 12, a lower surface 21B of the liquid immersion member 13B includes a first surface 25B, which holds the liquid LQ between itself and the substrate P during the exposure of the substrate P, and a third surface 27B, which is disposed around the first surface 25B. The first surface 25B is substantially parallel to the front surface of the substrate P (i.e., the XY plane). In the present embodiment, the first surface 25B has a substantially square external shape in the XY plane.

The third surface 27B includes the liquid recovery surface. The third surface 27B includes the front surface (i.e., the lower surface) of the porous member 30 that is disposed in the liquid recovery port 32. The third surface 27B is substantially parallel to the front surface of the substrate P (i.e., the XY plane). In the present embodiment, the third surface 27B is disposed such that it surrounds the optical path K of the exposure light EL and the first surface 25B.

In the present embodiment, the first surface 25B and the third surface 27B have different positions in the Z axial directions. In the present embodiment, the third surface 27B is disposed on the +Z side of the first surface 25B. Namely, the third surface 27B is disposed at a position at which it is further from the front surface of the substrate P than the first surface 25B is. In the present embodiment, a step 29B is formed between the first surface 25B and the third surface 27B.

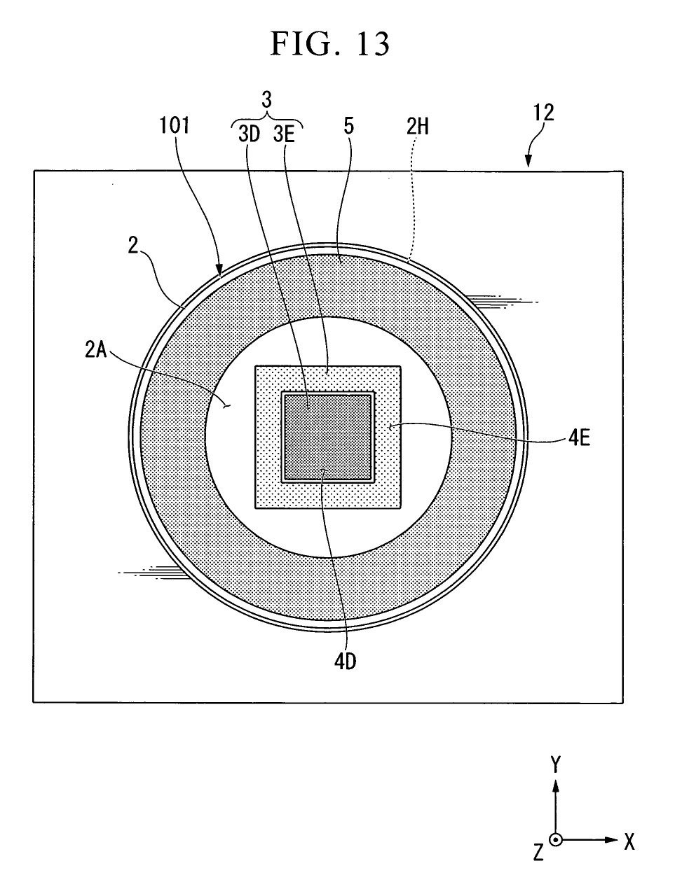

FIG. 13 is a plan view that shows the state wherein a cleaning tool 101 according to the present embodiment is held by a substrate holding part 2H. The cleaning tool 101 comprises the cleaning member 3 that comprises: a first cleaning member 3D, which has an upper surface 4D that is capable of contacting the first surface 25B of the liquid immersion member 13B; and a second cleaning member 3E, which has an upper surface 4E that is capable of contacting the third surface 27B. The first and second cleaning members 3D, 3E are disposed above the base member 2. The circumferential wall member 5 is disposed above the base member 2 around the first and second cleaning members 3D, 3E.

The upper surface 4D of the first cleaning member 3D and the first surface 25B of the liquid immersion member 13B have substantially the same external shape. The upper surface 4E of the second cleaning member 3E and the third surface 27B of the liquid immersion member 13B have substantially the same external shape. In addition, the second cleaning member 3E is taller than the first cleaning member 3D with respect to the front surface 2A of the base member 2.

In the present embodiment, too, the first cleaning member 3D and the first surface 25B sufficiently contact one another, as do the second cleaning member 3E and the third surface 27B, and therefore the cleaning tool 101 can clean the first and third surfaces 25B, 27B satisfactorily.

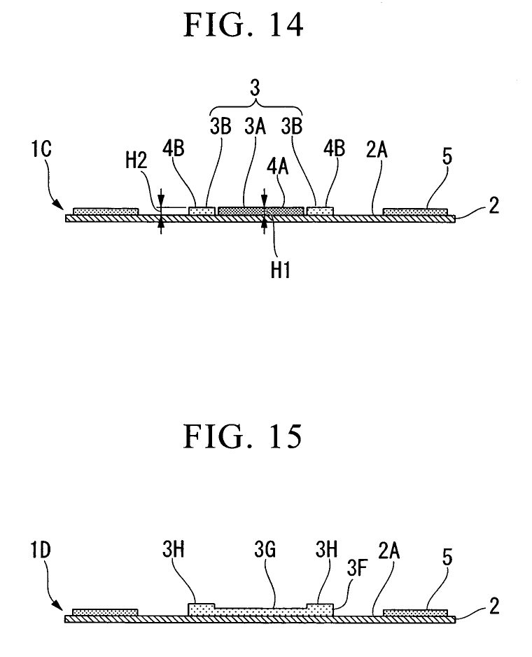

Furthermore, the first and second embodiments discussed above explained an exemplary case wherein the heights of the first and second cleaning members 3A, 3B (3D, 3E) differ in accordance with the profile (shape) of the lower surface 21 (21B) of the liquid immersion member 13 (13B); however, the first height H1 of the first cleaning member 3A and the second height H2 of the second cleaning members 3B may be the same as in, for example, a cleaning tool 1C shown in FIG. 14. The first and second cleaning members 3A, 3B, which are made of sponge, expand and compress; therefore, in the state wherein the first and second cleaning members 3A, 3B are not compressed (i.e., the state wherein external forces are not applied), the first and third surfaces 25, 27 of the liquid immersion member 13 and the upper surfaces 4A, 4B of the first and second cleaning members 3A, 3B can be brought into contact with one another—even if the first height H1 and the second height H2 are different—by pressing the first and second cleaning members 3A, 3B against the lower surface 21 of the liquid immersion member 13. In addition, if the first surface 25 and the third surfaces 27 of the liquid immersion member 13 have the same position (i.e., the same height) in the Z axial directions—that is, if the first surface 25 and the third surfaces 27 are flush with one another—then, by performing the cleaning process using a cleaning tool that has the first and second cleaning members 3A, 3B, which have equal heights with respect to the front surface 2A of the base member 2, the first and third surfaces 25, 27 can be cleaned satisfactorily.

Furthermore, each of the embodiments discussed above explained an exemplary case wherein the first portion 3A (3D) and the second portions 3B (3E) of the cleaning member 3 are spaced apart, but they may be integrated in a single member as in, for example, a cleaning member 3F of a cleaning tool 1D shown in FIG. 15. In addition, a first portion 3G and second portions 3H, which have different heights with respect to the front surface 2A of the base member 2, can be provided to the single cleaning member 3F. In addition, the upper surfaces of the cleaning member 3F may be flat.

Furthermore, in each of the embodiments discussed above, after the cleaning member 3 and the lower surface 21 of the liquid immersion member 13 are brought into contact with one another, the liquid immersion member 13 is cleaned in the state wherein the cleaning member 3 is substantially stationary; however, the liquid immersion member 13 may be cleaned by moving the cleaning member 3 and the liquid immersion member 13 relative to one another in the XY directions in the state wherein the cleaning member 3 and the liquid immersion member 13 have been brought into contact with one another.

Furthermore, in each of the embodiments discussed above, the transport system 14, which is capable of transporting the substrate P, performs the operation of loading the cleaning tool 1 onto the substrate stage 12 and the operation of unloading the cleaning tool 1 from the substrate stage 12; however, a transport system for transporting the cleaning tool 1 may be provided separately from the transport system 14, which is capable of transporting the substrate P, and that transport system may be used to perform the operation of loading the cleaning tool 1 and the operation of unloading the cleaning tool 1. In addition, the operation of loading the cleaning tool 1 onto the substrate stage 12 and the operation of unloading the cleaning tool 1 from the substrate stage 12 may be performed by an operator.

Furthermore, each of the embodiments discussed above explained an exemplary case wherein the cleaning member 3 is a sponge, but the cleaning member 3 is not limited thereto. Anything can be used as the cleaning member 3 provided that it is a porous member whose effect on the member to be cleaned is small and that can be permeated with the cleaning liquid LC. For example, a sintered member (e.g., sintered metal) wherein numerous pores are formed or a foam member (e.g., metal foam) may be used as the cleaning member 3.

In addition, the cleaning member 3 is not limited to a porous member. For example, dust-free paper suitable for clean rooms, wherein fibrous members are bundled like brushes, may be used as the cleaning member 3.

Furthermore, each of the embodiments discussed above explained an exemplary case wherein the circumferential wall member 5 is lower than the cleaning member 3 with respect to the front surface 2A of the base member 2, but the circumferential wall member 5 may be at the same height or higher than the cleaning member 3.

Furthermore, each of the embodiments discussed above explained an exemplary case wherein the circumferential wall member 5 is a sponge, but the circumferential wall member 5 is not limited thereto. A circumferential wall member of an arbitrary structure can be adopted as long as it can both prevent the cleaning liquid LC from leaking out and recover the cleaning liquid LC that exudes from the cleaning member 3. For example, using a sintered member (e.g., sintered metal) wherein numerous pores are formed or a foam member (e.g., metal foam) as the circumferential wall member 5 can both prevent the cleaning liquid LC from leaking out and recover (i.e., absorb) the cleaning liquid LC that exudes from the cleaning member 3.

In addition, the circumferential wall member 5 does not have to be a porous member. For example, the circumferential wall member 5 may be a ring member that is made of metal. Thereby, the cleaning liquid LC can be prevented from leaking to the outer side of the base member 2.

In addition, if the cleaning liquid LC that permeates the cleaning member 3 is unlikely to exude therefrom, then the circumferential wall member 5 may be omitted.

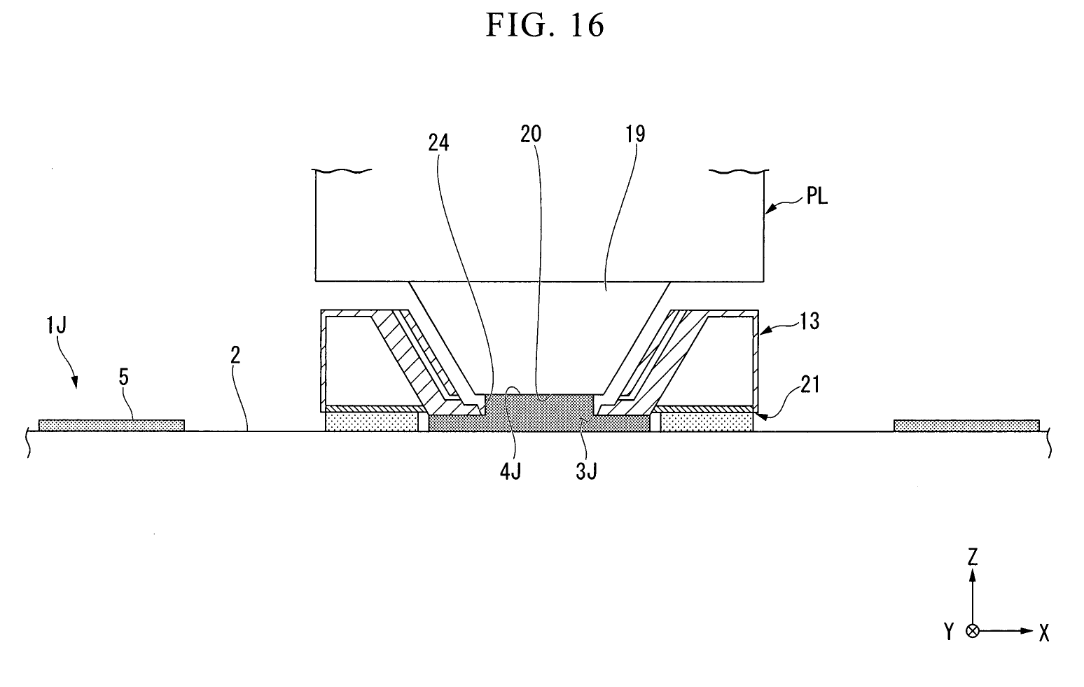

Furthermore, each of the embodiments discussed above explained an exemplary case wherein the cleaning tool 1 cleans the lower surface 21 of the liquid immersion member 13, but it is also possible to clean the emergent surface 20 of the last optical element 19. In such a case, the emergent surface 20 can be cleaned by providing a cleaning member 3J, which has an upper surface 4J that is capable of contacting the emergent surface 20 via the opening 24 of the liquid immersion member 13, on the base member 2 as in a cleaning tool 1J shown in, for example, FIG. 16.

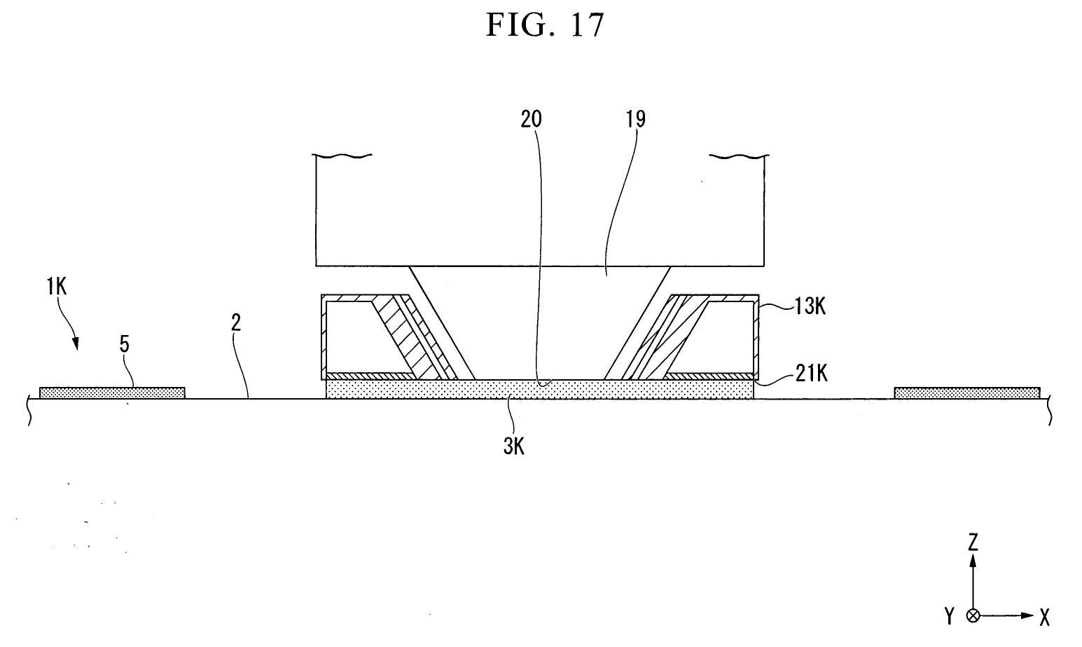

Furthermore, each of the embodiments discussed above explained an exemplary case wherein the liquid immersion member 13 comprises the lower plate part 23 that opposes part of the emergent surface 20 of the last optical element 19; however, if a liquid immersion member 13K is used that both has a structure wherein the lower plate part 23 is omitted and has a lower surface 21K that is substantially flush with the emergent surface 20 of the last optical element 19, as shown in, for example, FIG. 17, then the lower surface 21K of the liquid immersion member 13K and the emergent surface 20 of the last optical element 19 can be cleaned simultaneously using a cleaning member 3K of a cleaning tool 1K, as shown in FIG. 17.

As described above, the supply of the cleaning liquid LC from the liquid supply source (not shown) to the cleaning member 3 can be executed inside the exposure apparatus EX. In a case in which the exposure apparatus EX includes the liquid supply source, the cleaning liquid LC can be supplied from the liquid supply source to an upper surface of a member inside the exposure apparatus (e.g., the upper surface 12T of the substrate stage 12), so as to clean the upper surface of the member. In a case in which a plurality of types of the cleaning liquid (e.g., LC1, LC2) are used, only one type of the cleaning liquid can be supplied to the cleaning member 3 inside the exposure apparatus EX.

Furthermore, in each of the embodiments discussed above, the member inside the exposure apparatus EX that is to be cleaned may be, for example, part of the projection optical system PL (including a lens barrel), part of the mask stage 11, part of the substrate stage 12, or part of the illumination system IL; for example, by holding the cleaning tool with the mask holding part 1H of the mask stage 11, the cleaning tool held thereby can clean part of the illumination system IL or part of the projection optical system PL, or both.

Furthermore, each of the embodiments discussed above explained an exemplary case wherein the exposure apparatus EX is an immersion exposure apparatus that exposes the substrate P through the liquid LQ, but the exposure apparatus EX may be a dry-type exposure apparatus wherein the optical path K of the exposure light EL is filled with a gas instead of a liquid. In the case of a dry-type exposure apparatus, too, the emergent surface of the last optical element of the projection optical system can be cleaned using the cleaning tool explained in each of the embodiments discussed above.

### Third Embodiment

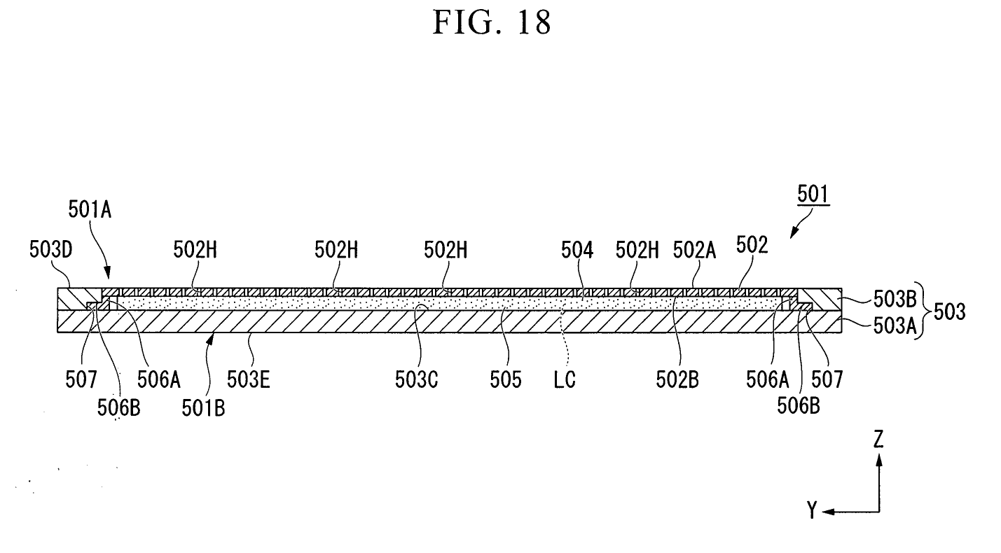

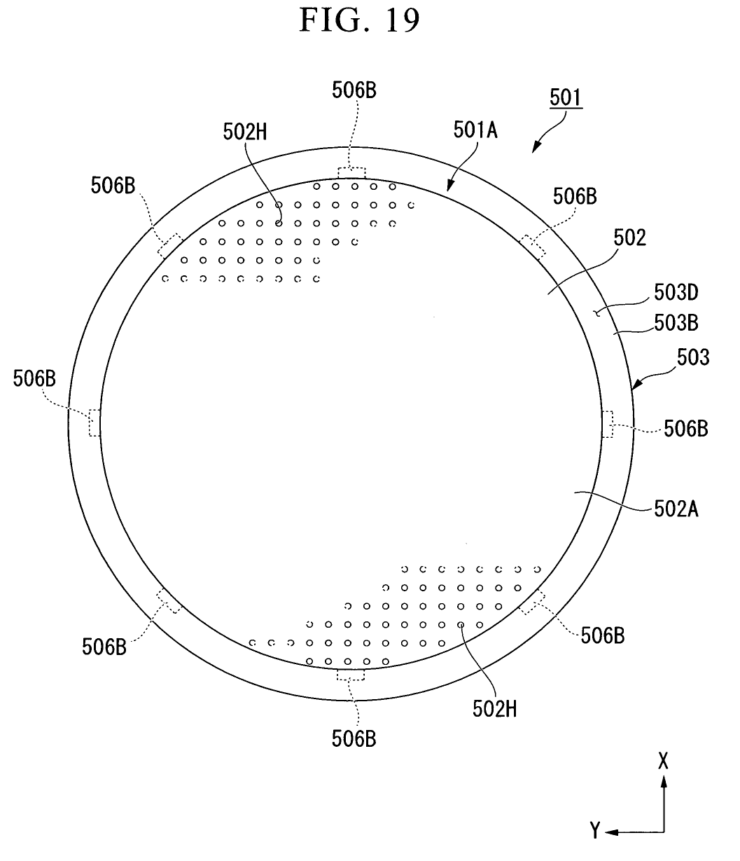

Next, a third embodiment will now be explained. In the explanation below, constituent parts that are identical or equivalent to those in the embodiment discussed above are assigned identical symbols, and the explanations thereof are therefore abbreviated or omitted. FIG. 18 is a side cross sectional view that shows one example of a cleaning tool 501 according to a third embodiment, and FIG. 19 is a plan view thereof. As discussed below, the cleaning tool 501 is loaded onto an exposure apparatus EX, which exposes a substrate P with exposure light EL through a liquid LQ, and cleans at least part of a member inside the exposure apparatus EX or a component, or both (hereinbelow, this is called the member to be cleaned).

In FIG. 18 and FIG. 19, the cleaning tool 501 comprises a circular porous plate 502 and a base member 503, which supports the porous plate 502. The porous plate 502 has: a front surface 502A; a rear surface 502B on the opposite side of the front surface 502A; and a plurality of holes 502H wherethrough the front surface 502A and the rear surface 502B on the opposite side of the front surface 502A communicate.

The cleaning tool 501 has an internal space 504, which faces the rear surface 502B. The internal space 504 includes at least part of a space between the base member 503 and the porous plate 502. The internal space 504 is capable of holding a liquid LC, which is for cleaning.

In the present embodiment, the cleaning tool 501 comprises a porous member 505, which is disposed in the internal space 504. At least part of the liquid LC in the internal space 504 is held by the porous member 505. In the present embodiment, the holes of the porous member 505 include open pores. The open pores are pores that are open to the outside air. The open pores are capable of holding liquid that flows thereinto. Furthermore, the porous member 5 may include closed pores. Furthermore, the porous member 505 does not have to be disposed in the internal space 504 as long as the liquid LC can be otherwise held therein.

The base member 503 comprises a plate part 503A and a circumferential wall part 503B, which is disposed along a circumferential edge of an upper surface 503C of the plate part 503A. The internal space 504 includes at least part of a space between the upper surface 503C of the plate part 503A and the rear surface 502B of the porous plate 502.

In the present embodiment, the porous plate 502 comprises: a plurality of first protruding parts 506A, which are disposed in a circumferential edge area of the rear surface 502B and protrude from the rear surface 502B in a direction substantially perpendicular thereto; and a plurality of second protruding parts 506B, each of which protrudes from its corresponding first protruding part 506A outward in a radial direction with respect to the center of the porous plate 502. The first and second protruding parts 506A, 506B are disposed in the circumferential edge area of the rear surface 502B such that they are substantially equispaced around it. The circumferential wall part 503B of the base member 503 has recessed parts 507, into which the second protruding parts 506B are inserted. The recessed parts 507 are disposed in the inner surface of the circumferential wall part 503B such that they are substantially equispaced around it.

The first protruding parts 506A and the second protruding parts 506B are integrated. In addition, the first protruding parts 506A and the porous plate 502 are fixed. In the present embodiment, the second protruding parts 506B of the porous plate 502 are held in the recessed parts 507, and thereby the porous plate 502 and the base member 503 are connected. A prescribed gap is formed between the edge (i.e., the outer side surface) of the porous plate 502 and the inner surface of the circumferential wall part 503B. The gap is of a size such that the liquid LC is prevented from leaking out of the internal space 504. Thus, in the present embodiment, the porous plate 502 and the base member 503 are not rigidly fixed, and therefore it is possible to prevent the porous plate 502 from deforming significantly-even if, for example, the porous plate 502 thermally expands.

In the present embodiment, the material properties of the porous plate 502 are selected in accordance with the member to be cleaned inside the exposure apparatus EX. In the present embodiment, the porous plate 502 has the same material properties as the member to be cleaned. In the present embodiment, the porous plate 502 is made of titanium. Furthermore, the porous plate 502 does not have the same material properties as the member to be cleaned.

In addition, in the present embodiment, the porous member 505 also has material properties that are the same as those of the member to be cleaned. In the present embodiment, the porous member 505 is a porous body made of titanium. Furthermore, the porous member 505 does not have to have the same material properties as the member to be cleaned. The porous plate 502 and the porous member 505 do not have to have the same material properties.

In the present embodiment, the base member 503 is made of a ceramic material. In the present embodiment, the base member 503 contains silicon carbide (SiC). Because a ceramic material that contains silicon carbide has a high rigidity, the rigidity of the entire cleaning tool 501 is ensured. Furthermore, the base member 503 does not have to be made of a ceramic material.

In the present embodiment, the liquid LC for cleaning is a liquid capable of cleaning the member inside the exposure apparatus EX. The liquid LC is also capable of eliminating foreign matter (i.e., contaminants) that adheres to the member inside the exposure apparatus EX. An alkali cleaning liquid that contains, for example, alkali can be used as the liquid LC. Using the alkali cleaning liquid as the liquid LC makes it possible to satisfactorily eliminate contaminants, such as organic substances, that adhere to the member inside the exposure apparatus EX.

In the present embodiment, the liquid LC for cleaning can be diluted with the liquid LQ for exposure. In the present embodiment, pure water (i.e., water) is used as the liquid LQ for exposure and an alkaline aqueous solution is used as the liquid LC for cleaning. In the present embodiment, the liquid LC may be an aqueous solution of tetramethylammonium hydroxide (TMAH). Furthermore, the liquid LC is not limited to an alkaline aqueous solution, and isopropyl alcohol (IPA) or the like may be used as the liquid LC.

In the present embodiment, the front surface 502A of the porous plate 502 is liquid repellent with respect to the liquid LQ and the liquid LC. In the present embodiment, a film that includes a liquid repellent material, such as fluorine, is formed on the front surface 502A of the porous plate 502.

In the present embodiment, the size of the holes 502H is optimized to prevent, for example, the liquid LC from leaking out (to the front surface 502A side) of the internal space 504 therethrough and the vaporized liquid LC from likewise being released from the internal space 504.

In the present embodiment, the cleaning tool 501 and the substrate P have substantially the same external shape. In the present embodiment, the substrate P may be a semiconductor wafer. In the present embodiment, the external shape of the cleaning tool 501 is substantially circular within the XY plane and has a diameter substantially the same as that of the substrate P. In addition, the cleaning tool 501 and the substrate P have substantially the same thickness. The cleaning tool 501 has an upper surface 501A, which is substantially parallel to the XY plane, and a lower surface 501B, which faces a direction opposite that faced by the upper surface 501A. The upper surface 501A includes the front surface 502A of the porous plate 502 and an upper surface 503D of the base member 503 (i.e., the circumferential wall part 503B), which is disposed around the front surface 502A. The lower surface 50B on the opposite side of the upper surface 501A includes a lower surface 503E of the plate part 503A of the base member 503. Furthermore, the cleaning tool 501 and the substrate P do not have to have the same external shape; however, as discussed below, it is preferable that the cleaning tool 501 have an external shape such that the cleaning tool 501 can be transported by a transport member that also transports the substrate P.

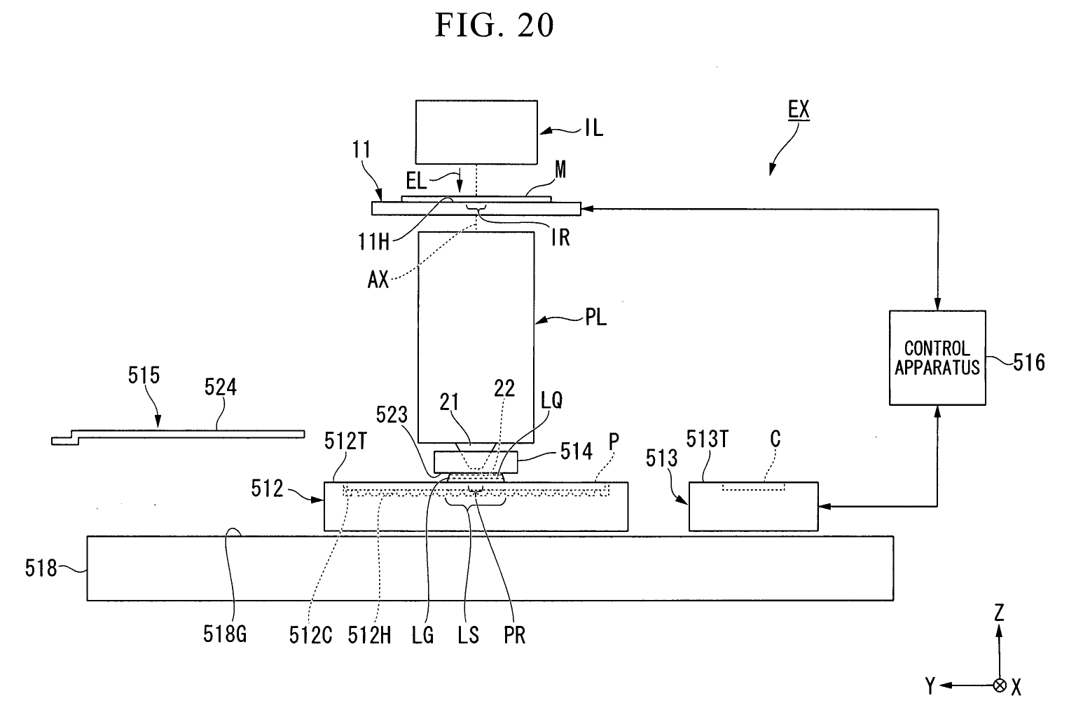

The following text explains one example of the exposure apparatus EX that comprises the member to be cleaned. FIG. 20 is a schematic block diagram that shows one example of the exposure apparatus EX according to the present embodiment. The exposure apparatus EX of the present embodiment is an immersion exposure apparatus that exposes the substrate P with the exposure light EL that passes through the liquid LQ for exposure. As discussed above, in the present embodiment, pure water (i.e., water) is used as the liquid LQ.

In addition, the present embodiment explains an exemplary case wherein the exposure apparatus EX is an exposure apparatus that comprises a moveable substrate stage 512, which holds the substrate P, and a moveable measurement stage 513, which does not hold the substrate P and whereon a measuring instrument C that measures the exposure light EL are mounted, as disclosed in, for example, U.S. Pat. No. 6,897,963 and European Patent Application Publication No. 1713113.

In FIG. 20, the exposure apparatus EX comprises: a movable mask stage 511 that holds a mask M; the movable substrate stage 512 that holds the substrate P; the moveable measurement stage 513 whereon the measuring instrument C is mounted; an illumination system IL that illuminates the mask M with the exposure light EL; a projection optical system PL that projects an image of a pattern of the mask M, which is illuminated by the exposure light EL, to the substrate P; a liquid immersion member 514, which is capable of forming an immersion space LS such that at least part of an optical path of the exposure light EL is filled with the liquid LQ; a transport system 515, which is capable of transporting the substrate P; and a control apparatus 516 that controls the operation of the entire exposure apparatus EX.

The illumination system IL illuminates a prescribed illumination region IR with the exposure light EL, which has a uniform luminous flux intensity distribution. The illumination region IR includes an irradiation position of the exposure light EL that emerges from the illumination system IL.

The mask stage 511 is capable of moving to the illumination region IR. The mask stage 511 comprises a mask holding part 511H that releasably holds the mask M. In the present embodiment, the mask holding part 511H holds the mask M such that a patterned surface (i.e., a lower surface) of the mask M is substantially parallel to the XY plane. The mask stage 511, in the state wherein it holds the mask M, is capable of moving—by the operation of a drive system that comprises actuators such as linear motors—in three directions: the X axial, Y axial, and θZ directions.

The projection optical system PL radiates the exposure light EL to a prescribed projection region PR. The projection region PR includes an irradiation position of the exposure light EL that emerges from the projection optical system PL.

The substrate stage 512 is capable of moving to the projection region PR. The substrate stage 512 is capable of moving on a guide surface 518G of a base member 518 that includes the projection region PR. The substrate stage 512 comprises a substrate holding part 512H, which releasably holds the substrate P. The substrate holding part 512H comprises a so-called pinching mechanism, as disclosed in, for example, U.S. Patent Application Publication No. 2007/0177125. In the present embodiment, the substrate holding part 512H holds the substrate P such that the front surface (i.e., the exposure surface) of the substrate P is substantially parallel to the XY plane. The substrate stage 512, in the state wherein it holds the substrate P, is capable of moving—by the operation of a drive system that comprises actuators such as linear motors—in six directions: the X axial, Y axial, Z axial, θX, θY, and θZ directions. The substrate stage 512 has an upper surface 512T, which is disposed around the substrate holding part 512H. The substrate holding part 512H is disposed in a recessed part 512C, which is provided on the substrate stage 512. The upper surface 512T of the substrate stage 512 is a flat surface that is substantially parallel to the XY plane. The front surface of the substrate P held by the substrate holding part 512H and the upper surface 512T of the substrate stage 512 are disposed in substantially the same plane (i.e., they are substantially flush with one another).

The measurement stage 513 is capable of moving to the projection region PR. The measurement stage 513 is capable of moving on the guide surface 518G of the base member 518 that includes the projection region PR. The measurement stage 513, in the state wherein the measuring instrument C is mounted thereon, is capable of moving—by the operation of a drive system that comprises actuators such as linear motors—in six directions: the X axial, Y axial, Z axial, θX, θY, and θZ directions. The measurement stage 513 has an upper surface 513T. The upper surface 513T of the measurement stage 513 is a flat surface that is substantially parallel to the XY plane.

In the present embodiment, an interferometer system (not shown) measures the positions of the mask stage 511, the substrate stage 512, and the measurement stage 513. When an exposing process or a prescribed measurement process is performed on the substrate P, the control apparatus 516 controls the positions of the mask stage 511 (i.e., the mask M), the substrate stage 512 (i.e., the substrate P), and the measurement stage 513 (i.e., the measuring instrument C) based on the measurement results of the interferometer system.

The liquid immersion member 514 is capable of forming the immersion space LS such that at least part of the optical path of the exposure light EL is filled with the first liquid LQ. The immersion space LS is a portion (i.e., a space or area) that is filled with the liquid LQ. The liquid immersion member 514 is disposed in the vicinity of a last optical element 521, which is the optical element of the plurality of optical elements of the projection optical system PL that is closest to the image plane of the projection optical system PL. In the present embodiment, the liquid immersion member 514 is a ring shaped member and is disposed around the optical path of the exposure light EL. In the present embodiment, at least part of the liquid immersion member 514 is disposed around the last optical element 521.

The last optical element 521 has an emergent surface 522 wherefrom the exposure light EL emerges and travels toward the image plane of the projection optical system PL. In the present embodiment, the immersion space LS is formed such that the optical path of the exposure light EL between the last optical element 521 and an object, which is disposed at the irradiation position (i.e., the projection region PR) of the exposure light EL that emerges from the last optical element 521, is filled with the liquid LQ. In the present embodiment, the object that is capable of being disposed in the projection region PR includes at least one member selected from the group consisting of the substrate stage 512, the substrate P held by the substrate stage 512, the measurement stage 513, and the measuring instrument C mounted on the measurement stage 513.

In the present embodiment, the liquid immersion member 514 has a lower surface 523 that is capable of opposing the object disposed in the projection region PR. The space between the lower surface 523 of the liquid immersion member 514 and the front surface of the substrate P is capable of holding the liquid LQ such that the optical path of the exposure light EL that impinges the substrate P during its exposure is filled with the liquid LQ. Holding the liquid LQ between the emergent surface 522 and the lower surface 523 on one side and the front surface of the object on the other side forms the immersion space LS such that the optical path of the exposure light EL between the last optical element 521 and the object is filled with the liquid LQ.

In the present embodiment, when the substrate P is being irradiated with the exposure light EL, the immersion space LS is already formed such that part of the area of the front surface of the substrate P that includes the projection region PR is covered with the liquid LQ. At least part of an interface LG (i.e., a meniscus or edge) of the liquid LQ is formed between the lower surface 523 of the liquid immersion member 514 and the front surface of the substrate P. Namely, the exposure apparatus EX of the present embodiment adopts a local liquid immersion system.

The upper surface 512T and the upper surface 513T are capable of opposing the emergent surface 522 and the lower surface 523. In the present embodiment, the control apparatus 516 can synchronously move the substrate stage 512 and the measurement stage 513 in the X and Y directions with respect to the last optical element 521 and the liquid immersion member 514 while, at the same time, causing the emergent surface 522 and the lower surface 523 to oppose either the upper surface 512T or the upper surface 513T in the state wherein the upper surface 512T and the upper surface 513T are brought into proximity or contact with one another such that a space is continuously formed wherein the liquid LQ can be held between the substrate stage 512 or the measurement stage 513 on one side and the last optical element 521 and the liquid immersion member 514 on the other side, as disclosed in, for example, U.S. Patent Application Publication No. 2006/0023186 and U.S. Patent Application Publication No. 2007/0127006. Thereby, the control apparatus 516 can switch between the state wherein the immersion space LS can be formed between the last optical element 521 and the liquid immersion member 514 on one side and the substrate stage 512 on the other side and the state wherein the immersion space LS can be formed between the last optical element 521 and the liquid immersion member 514 on one side and the measurement stage 513 on the other side. Namely, the immersion space LS of the liquid LQ can be moved between the upper surface 512T of the substrate stage 512 and the upper surface 513T of the measurement stage 513 while preventing the liquid LQ from leaking out.

In the explanation below, the operation that synchronously moves the substrate stage 512 and the measurement stage 513 in the X and Y directions with respect to the last optical element 521 and the liquid immersion member 514 while causing the emergent surface 522 and the lower surface 523 to oppose the upper surface 512T or the upper surface 513T in the state wherein the upper surface 512T and the upper surface 513T have been brought into close proximity or contact with one another is called a “scrum” movement where appropriate.

The transport system 515 comprises a transportable transport member 524, which supports the substrate P. The transport member 524 executes at least one of the following operations: a loading operation that loads the unexposed substrate P onto the substrate holding part 512H, and an unloading operation that unloads the exposed substrate P from the substrate holding part 512H. The control apparatus 516 is capable of performing a substrate exchange operation, which includes both the unloading operation that uses the transport system 515 to unload an exposed substrate P from the substrate stage 512 (i.e., the substrate holding part 512H) and the loading operation that loads the unexposed substrate P to be exposed next onto the substrate stage 512 (i.e., the substrate holding part 512H).

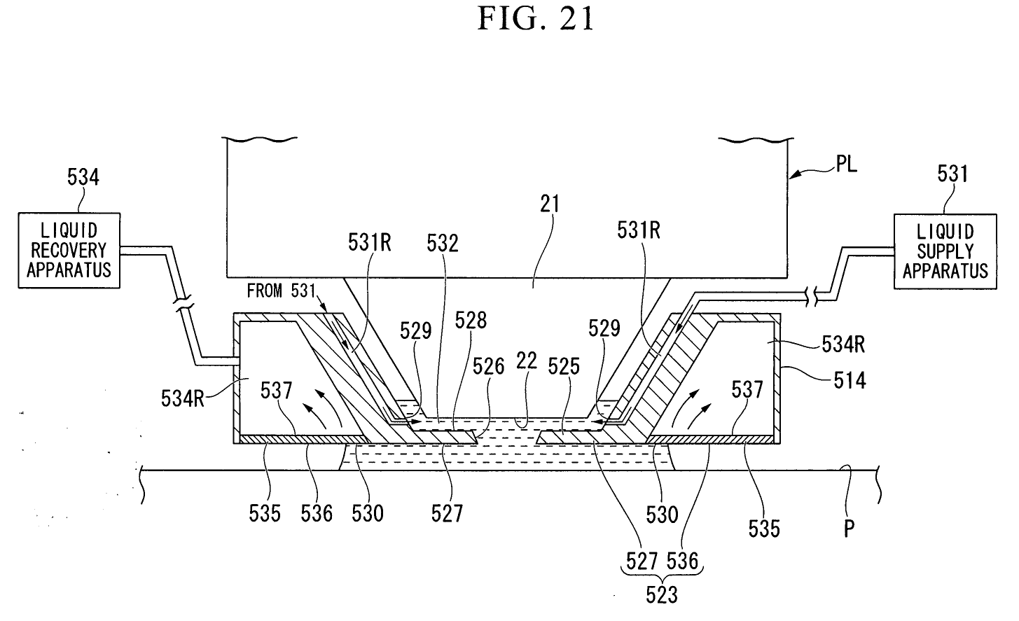

The following text explains the liquid immersion member 514, referencing FIG. 21. FIG. 21 is a side cross sectional view that shows the vicinity of the liquid immersion member 514. Furthermore, the following text principally explains an exemplary state wherein the substrate P is disposed at a position at which it opposes both the emergent surface 522 of the last optical element 521 and the lower surface 523 of the liquid immersion member 514; however, as discussed above, it is also possible to dispose an object other than the substrate P, such as the substrate stage 512 or the measurement stage 513, at a position at which it opposes both the emergent surface 522 of the last optical element 521 and the lower surface 523 of the liquid immersion member 514.

The liquid immersion member 514 is a ring shaped member and is disposed around the optical path of the exposure light EL. At least part of the liquid immersion member 514 is disposed around the last optical element 521. In the present embodiment, the liquid immersion member 514 comprises a plate part 525, at least part of which is disposed between the emergent surface 522 of the last optical element 521 and the front surface of the substrate P in the Z axial directions. The plate part 525 has an opening 526 at its center. In addition, the plate part 525 has: a lower surface 527, which is disposed around the opening 526 and is capable of opposing the substrate P (i.e., the object) disposed at the irradiation position (i.e., the projection region PR) of the exposure light EL; and an upper surface 528, which faces the direction opposite that faced by the lower surface 527. At least part of the upper surface 528 on the opposite side of the lower surface 527 opposes part of the emergent surface 522. The exposure light EL that emerges from the emergent surface 522 can pass through the opening 526. For example, during an exposure of the substrate P, the exposure light EL that emerges from the emergent surface 522 passes through the opening 526 and is radiated through the liquid LQ to the front surface of the substrate P.

In addition, the liquid immersion member 514 comprises supply ports 529, which are capable of supplying the liquid LQ, and a recovery port 530, which is capable of recovering the liquid LQ. The supply ports 529 are connected to a liquid supply apparatus 531 via passageways 531R. The liquid supply apparatus 531 is capable of supplying the liquid LQ, which is pure and temperature adjusted, to the supply ports 529. Each passageway 531R comprises a supply passageway, which is formed inside the liquid immersion member 514, and a passageway, which is formed from a supply pipe that connects the supply passageway and the liquid supply apparatus 531. The liquid LQ fed from the liquid supply apparatus 531 is supplied to each of the supply ports 529 through the corresponding passageway 531R. The supply ports 529 are disposed in the vicinity of the optical path at prescribed positions in the liquid immersion member 514 that face the optical path. In the present embodiment, the supply ports 529 supply the liquid LQ to the space 532 between the emergent surface 522 and the upper surface 528. The liquid LQ supplied to the space 532 via the supply ports 529 is supplied to the substrate P via the opening 526.

The recovery port 530 is capable of recovering the liquid LQ on the substrate P. The recovery port 530 is connected to a liquid recovery apparatus 534 via a passageway 534R. The liquid recovery apparatus 534 comprises a vacuum system and is capable of recovering the liquid LQ by suctioning it via the recovery port 530. The passageway 534R comprises a recovery passageway, which is formed inside the liquid immersion member 514, and a passageway, which is formed from a recovery pipe that connects the recovery passageway and the liquid recovery apparatus 534. The liquid LQ recovered via the recovery port 530 is recovered by the liquid recovery apparatus 534 through the passageway 534R.

In the present embodiment, the recovery port 530 is disposed around the optical path of the exposure light EL. The recovery port 530 is disposed at a prescribed position in the liquid immersion member 514 such that it is capable of opposing the front surface of the substrate P. The recovery port 530 is capable of recovering at least part of the liquid LQ on the substrate P that opposes the lower surface 523 of the liquid immersion member 514.

In the present embodiment, a porous member 535 is disposed in the recovery port 530. In the present embodiment, the porous member 535 is a plate shaped member and comprises: a lower surface 536, which is capable of opposing the substrate P; an upper surface 537, which faces the direction opposite that faced by the lower surface 536; and a plurality of holes, which connect the lower surface 536 and the upper surface 537 on the opposite side thereof. The liquid LQ on the substrate P can flow into the recovery passageway 534R via the holes of the porous member 535. By the operation of the liquid recovery apparatus 534, the liquid LQ on the substrate P that contacts, for example, the lower surface 536 of the porous member 535 flows into the recovery passageway 534R and is recovered by the liquid recovery apparatus 534.

In the present embodiment, the lower surface 523 of the liquid immersion member 514 includes the lower surface 527 of the plate part 525 and the lower surface 536 of the porous member 535, which is disposed around the lower surface 527 and is capable of opposing the substrate P.

In the present embodiment, during the exposure of the substrate P, the control apparatus 516 is capable of forming the immersion space LS with the liquid LQ between the last optical element 521 and the liquid immersion member 514 on one side and the substrate P (i.e., the object) on the other side by performing a recovery operation, wherein the liquid recovery port 530 is used to recover the liquid LQ, in parallel with a supply operation, wherein the supply ports 529 are used to supply the liquid LQ.

In the present embodiment, at least the plate part 525 and the porous member 535, which form the lower surface 523, are made of titanium. In the present embodiment, a prescribed part of the liquid immersion member 514 that contacts the liquid LQ is made of titanium.

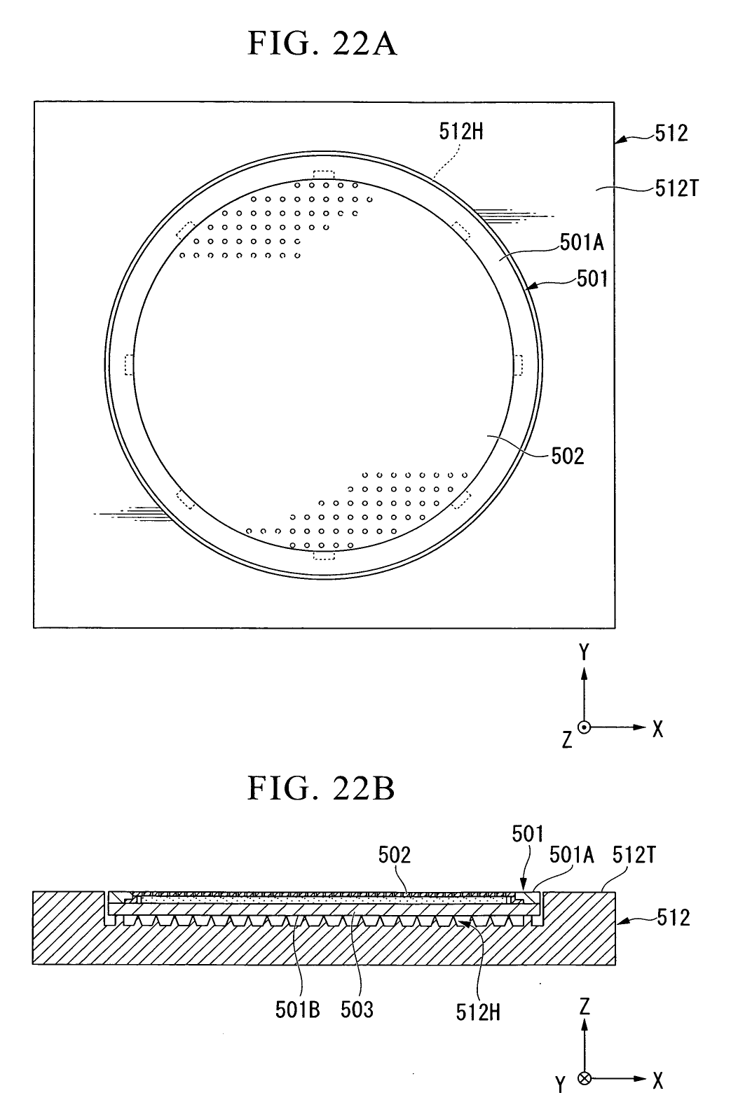

FIG. 22A is a plan view that shows the state wherein the substrate holding part 512H holds the cleaning tool 501, and FIG. 22B is a side cross sectional view thereof. As discussed above, the external shape of the cleaning tool 501 is substantially the same as that of the substrate P. As shown in FIGS. 22A and 22B, the substrate holding part 512H is capable of holding the cleaning tool 501. In the present embodiment, the substrate holding part 512H releasably holds the lower surface 501B (i.e., the base member 503) of the cleaning tool 501. The upper surface 501A of the cleaning tool 501 held by the substrate holding part 512H is substantially the same as the upper surface 512T of the substrate stage 512.

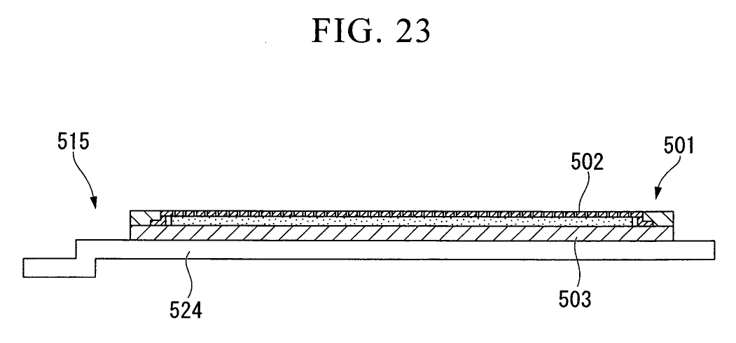

FIG. 23 shows one example of the operation of the transport system 515 according to the present embodiment. In the present embodiment, the transport system 515 is capable of transporting the cleaning tool 501. The transport member 524 is capable of supporting the cleaning tool 501. The transport member 524 is capable of performing at least one of the following operations: a loading operation that loads the cleaning tool 501 onto the substrate holding part 512H, and an unloading operation that unloads the cleaning tool 501 from the substrate holding part 512H. As shown in FIG. 23, in the present embodiment, the transport member 524 supports the base member 503 of the cleaning tool 501.

As discussed above, in the present embodiment, the base member 503 is made of a ceramic material. Because the base member 503 is made of a ceramic material, the transport member 524 is not contaminated while it supports the base member 503. In addition, even if the transport member 524 supports the substrate P after the transport member 524 has supported the base member 503, the substrate P will be unaffected.

In addition, in the present embodiment, the control apparatus 516 sets the acceleration of the transport member 524 when it transports the cleaning tool 501 lower than when it transports the substrate P. Thereby, the liquid LC held in the internal space 504 is prevented from leaking out of, for example, the holes of the porous plate 502 during transport by the transport member 524.

The following text explains one example of a method of using the exposure apparatus EX discussed above to expose the substrate P.

To start the process of exposing the substrate P, the control apparatus 516 moves the substrate stage 512 to a substrate exchange position, which is spaced apart from the projection region PR, and uses the transport system 515 to load the unexposed substrate P onto the substrate stage 512, which is disposed at the substrate exchange position. When the substrate P is loaded onto the substrate stage 512, the control apparatus 516 controls the transport system 515 such that the substrate P is transported by the transport member 524 at the prescribed velocity and acceleration. When the substrate stage 512 is disposed at the substrate exchange position, the measurement stage 513 is disposed at the projection region PR and the immersion space LS is formed between the last optical element 521 and liquid immersion member 514 on one side and the measurement stage 513 on the other side.

After the unexposed substrate P has been loaded onto the substrate stage 512, the control apparatus 516 moves the substrate stage 512 toward the projection region PR. The control apparatus 516 performs the “scrum” movement and switches from the state wherein the immersion space LS is formed between the last optical element 521 and the liquid immersion member 514 on one side and the measurement stage 513 on the other side to the state wherein the immersion space LS is formed between the last optical element 521 and the liquid immersion member 514 on one side and the substrate stage 512 on the other side. Thereby, the immersion space LS is formed such that the optical path of the exposure light EL between the last optical element 521 and the liquid immersion member 514 on one side and the substrate P, which is held by the substrate stage 512, on the other side is filled with the liquid LQ.

Also, the exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. When the substrate P is to be exposed, the control apparatus 516 controls the mask stage 511 and the substrate stage 512 to move the mask M and the substrate P in the prescribed scanning directions within the XY plane. In the present embodiment, the scanning directions (i.e., the synchronous movement directions) of both the substrate P and the mask M are the Y axial directions. The control apparatus 516 radiates the exposure light EL to the substrate P through the projection optical system PL and the liquid LQ in the immersion space LS on the substrate P while moving the substrate P in one of the Y axial directions with respect to the projection region PR of the projection optical system PL and moving the mask M, synchronized to the movement of the substrate P, in the other Y axial direction with respect to the illumination region IR of the illumination system IL. Thereby, the image of the pattern of the mask M is projected to the substrate P, which is thereby exposed by the exposure light EL.

The exposed substrate P is then unloaded from the substrate stage 512. To unload the exposed substrate P from the substrate stage 512, the control apparatus 516 moves the substrate stage 512 to the substrate exchange position. The control apparatus 516 uses the transport system 515 to unload the exposed substrate P from the substrate stage 512, which is disposed at the substrate exchange position.

The control apparatus 516 successively performs immersion exposures on a plurality of substrates P by repetitively performing the loading operation, which loads an unexposed substrate P, the exposure operation, which exposes the substrate P, and the unloading operation, which unloads the exposed substrate P.

During the exposure of the substrate P, it is possible that a substance (e.g., an organic substance like a photosensitive material) produced (i.e., eluted) from the substrate P will intermix with the liquid LQ of the immersion space LS as foreign matter (i.e., as a contaminant). In addition, along with the substance produced by the substrate P, foreign matter suspended in midair and the like might intermix with the liquid LQ of the immersion space LS. During the exposure of the substrate P, the liquid LQ of the immersion space LS contacts the lower surface 523 of the liquid immersion member 514. In addition, in the present embodiment, during the exposure of the substrate P, the liquid LQ of the immersion space LS also contacts the upper surface 512T of the substrate stage 512. Accordingly, if foreign matter intermixes with the liquid LQ of the immersion space LS, then foreign matter might adhere to the lower surface 523 of the liquid immersion member 514 and the upper surface 512T of the substrate stage 512. If the foreign matter is left in a state wherein it adheres to the liquid contact surface, that is, the surface of the member inside the exposure apparatus EX that contacts the liquid LQ, then that foreign matter might, for example, adhere to the substrate P during an exposure or contaminate the liquid LQ supplied via the supply ports 529. In addition, if either the lower surface 523 of the liquid immersion member 514 or the upper surface 512T of the substrate stage 512 becomes contaminated, then satisfactorily forming the immersion space LS may no longer be possible. As a result, exposure failures might occur.

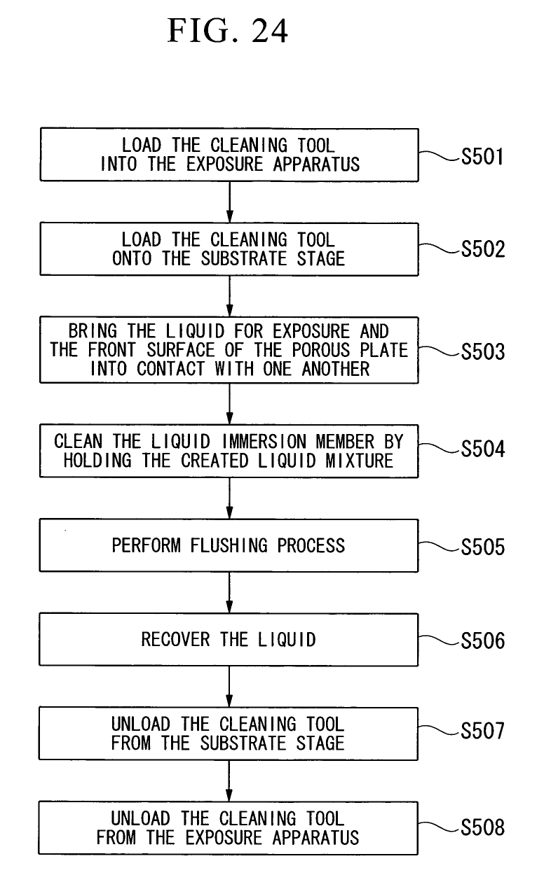

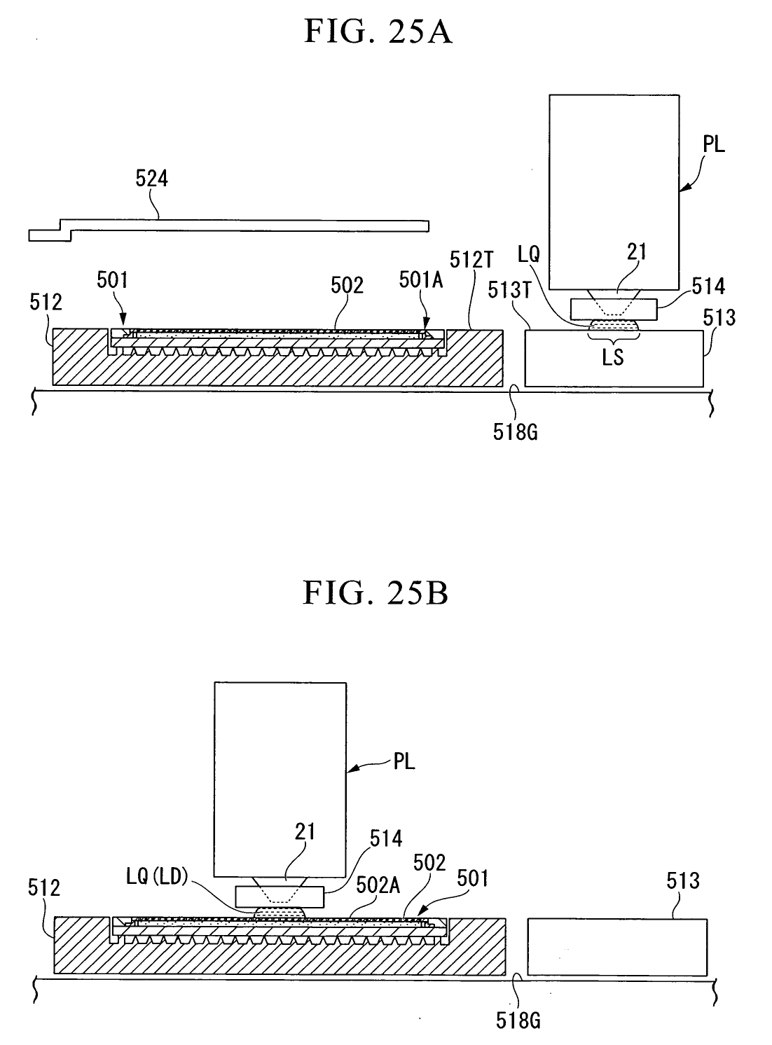

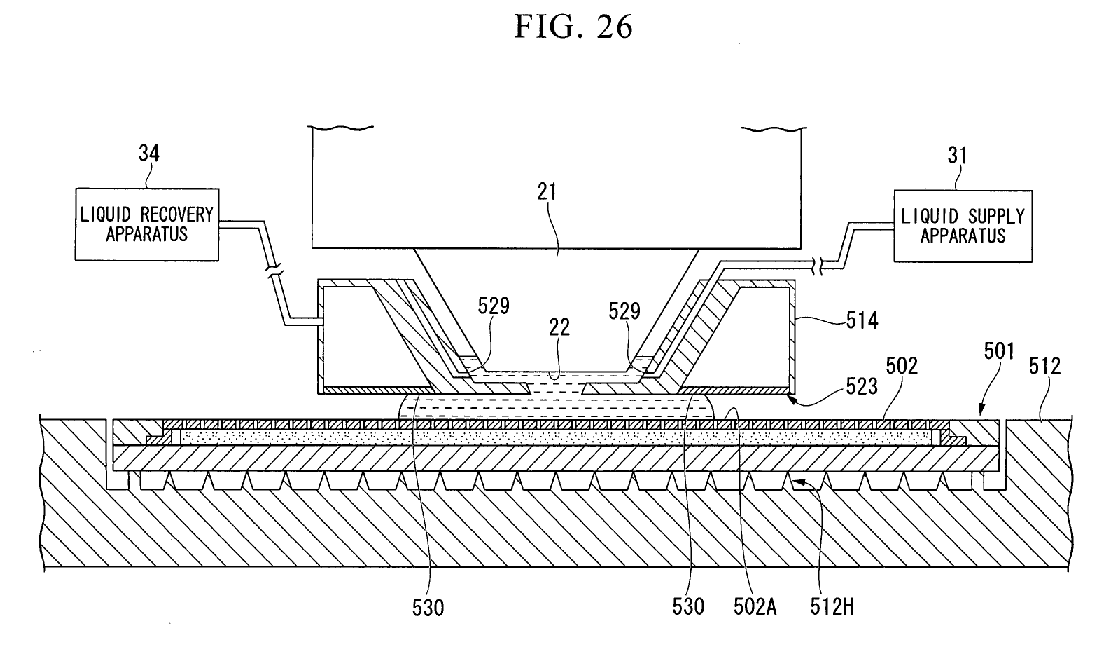

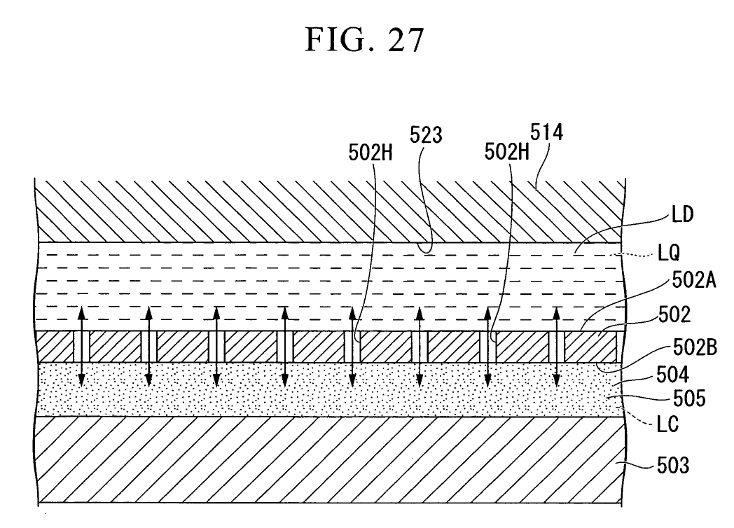

Accordingly, in the present embodiment, a cleaning process, which cleans the member inside the exposure apparatus EX using the cleaning tool 501 discussed above, is performed with a prescribed timing. The following text explains a method of cleaning the member inside the exposure apparatus EX using the cleaning tool 501, referencing the flow chart in FIG. 24 and the schematic drawings in FIG. 25A, FIG. 25B, FIG. 26, and FIG. 27. The present embodiment explains an exemplary case wherein the lower surface 523 of the liquid immersion member 514 is cleaned using the cleaning tool 501.

To clean the liquid immersion member 514, the cleaning tool 501 is loaded into the exposure apparatus EX (step S501). Before the cleaning process is performed, the liquid LC is held in the internal space 504 of the cleaning tool 501. The transport system 515 transports the cleaning tool 501, which has been loaded into the exposure apparatus EX. The control apparatus 516 starts the loading operation, which uses the transport system 515 to load the cleaning tool 501 onto the substrate stage 512 (step S502).

To load the cleaning tool 501 onto the substrate stage 512, the control apparatus 516 moves the substrate stage 512 to the substrate exchange position. The transport system 515 performs the loading operation, wherein the base member 503 of the cleaning tool 501 is supported by the transport member 524 and the cleaning tool 501 is loaded onto the substrate stage 512 disposed at the substrate exchange position. The substrate stage 512 holds the loaded cleaning tool 501 with the substrate holding part 512H.

As discussed above, in the present embodiment, the acceleration set when the transport member 524 transports the cleaning tool 501 is lower than the acceleration when the transport member 524 transports the substrate P; this prevents the liquid LC of the internal space 504 from leaking out during, for example, transport.

As shown in FIG. 25A, when the cleaning tool 501 is loaded onto the substrate stage 512, the immersion space LS is formed by disposing the measurement stage 513 at the position at which it opposes the last optical element 521 and the liquid immersion member 514 and holding the liquid LQ between the last optical element 521 and the liquid immersion member 514 on one side and the measurement stage 513 on the other side.

After the cleaning tool 501 has been loaded onto the substrate stage 512, the control apparatus 516 moves the substrate stage 512 toward the projection region PR. The control apparatus 516 performs the “scrum” movement by switching from the state wherein the immersion space LS is formed with the liquid LQ between the last optical element 521 and the liquid immersion member 514 on one side and the measurement stage 513 on the other side to the state wherein the immersion space LS is formed with the liquid LQ between the last optical element 521 and the liquid immersion member 514 on one side and the cleaning tool 501 on the substrate stage 512 on the other side. Namely, the control apparatus 516 moves the substrate stage 512 such that the front surface 502A of the cleaning tool 501 held by the substrate holding part 512H is disposed at a position at which it opposes the last optical element 521 and the liquid immersion member 514. Thereby, as shown in FIG. 25B, the liquid LQ is held between the last optical element 521 and the liquid immersion member 514 on one side and the cleaning tool 501 held by the substrate stage 512 on the other side, and the liquid LQ of the immersion space LS and the front surface 502A of the porous plate 502 contact one another (step S503).

FIG. 26 shows the state wherein the front surface 502A of the cleaning tool 501 held by the substrate stage 512 is disposed at the position at which it opposes the emergent surface 522 of the last optical element 521 and the lower surface 523 of the liquid immersion member 514, and FIG. 27 schematically shows the vicinity of the porous plate 502. In the present embodiment, as shown in FIG. 26, after the cleaning tool 501 has moved to the position at which it opposes the last optical element 521 and the liquid immersion member 514, the control apparatus 516 stops both the supply operation, wherein the liquid LQ is supplied via the supply ports 529, and the recovery operation, wherein the liquid is recovered via the recovery port 530.

By bringing the liquid LQ of the immersion space LS and the front surface 502A of the porous plate 502 into contact with one another, a liquid mixture LD of the liquid LQ on the front surface 502A and the liquid LC is created. As shown in FIG. 27, by bringing the liquid LQ and the front surface 502A of the porous plate 502 into contact with one another, a phenomenon occurs wherein, via the holes 502H, at least part of the liquid LQ on the front surface 502A side moves to the internal space 504 and at least part of the liquid LC in the internal space 504 moves to the front surface 502A side. Thereby, the liquid mixture LD of the liquid LQ and the liquid LC is created. In the present embodiment, the liquid LC can be diluted by the liquid LQ, and therefore the liquid mixture LD is created smoothly.

In the present embodiment, the size of the holes 502H is optimized such that the liquid LC in the internal space 504 is prevented from moving to the front surface 502A side, for example, during the transport of the cleaning tool 501 or in the state wherein the front surface 502A and the liquid LQ are not in contact with one another. By bringing the liquid LQ of the immersion space LS and the front surface 502A into contact with one another, the phenomenon discussed above occurs and the liquid mixture LD of the liquid LQ on the front surface 502A and the liquid LC is created. The created liquid mixture LD is held between the emergent surface 522 of the last optical element 521 and the lower surface 523 of the liquid immersion member 514 on one side and the front surface 502A of the cleaning tool 501 on the other side. Thereby, an immersion space is formed with the liquid mixture LD between the lower surface 523 of the liquid immersion member 514 and the front surface 502A of the cleaning tool 501. In the present embodiment, the front surface 502A is liquid repellent with respect to the liquid LQ and the liquid LC (i.e., the liquid mixture LD), and therefore the immersion space of the liquid mixture LD is formed satisfactorily in the space between the lower surface 523 of the liquid immersion member 514 and the front surface 502A of the cleaning tool 501. By bringing the liquid mixture LD and the lower surface 523 of the liquid immersion member 514 into contact with one another, the liquid mixture LD cleans the lower surface 523 of the liquid immersion member 514 (step S504).

In the present embodiment, the porous plate 502 and the liquid immersion member 514 (i.e., the porous member 535) are each made of titanium and have the same material properties. In a case wherein the liquid mixture LD is an electrolytic solution, if the porous plate 502 and the liquid immersion member 514 were to have different material properties, then the porous plate 502 or the liquid immersion member 514, or both, might corrode if the liquid mixture LD were held therebetween. In the present embodiment, the porous plate 502 and the liquid immersion member 514 have the same material properties, and, as a result, the quality of the porous plate 502 and the liquid immersion member 514 can be maintained.

In addition, in the present embodiment, the supply operation wherein the liquid LQ is supplied via the supply ports 529 and the recovery operation wherein the liquid is recovered via the recovery port 530 are stopped when the liquid LQ and the front surface 502A are brought into contact with one another; this prevents a reduction in the proportion of the liquid LC in the liquid mixture LD.

In the present embodiment, during the cleaning process wherein the liquid mixture LD is used, the control apparatus 516 moves the cleaning tool 501 with respect to the liquid immersion member 514 by moving the substrate stage 512 in the X and Y directions. Thereby, the liquid mixture LD can contact and clean a broad area of the lower surface 523 of the liquid immersion member 514. In addition, in the present embodiment, the front surface 502A is liquid repellent with respect to the liquid LQ and the liquid LC (i.e., the liquid mixture LD), and therefore the immersion space of the liquid mixture LD can be formed satisfactorily between the lower surface 523 of the liquid immersion member 514 and the front surface 502A of the cleaning tool 501—even if the cleaning tool 501 has been moved.

In addition, in the present embodiment, the control apparatus 516 moves the substrate stage 512—in the state wherein the immersion space of the liquid mixture LD has been formed—such that the lower surface 523 of the liquid immersion member 514 and the upper surface 512T of the substrate stage 512 oppose one another. Thereby, the liquid mixture LD and at least part of the upper surface 512T disposed around the upper surface 501A of the cleaning tool 501 are brought into contact with one another, and the liquid mixture LD can clean at least part of the upper surface 512T.

In addition, in the present embodiment, in the state wherein the immersion space of the liquid mixture LD has been formed, the control apparatus 516 performs the “scrum” movement such that the lower surface 523 of the liquid immersion member 514 and the upper surface 513T of the measurement stage 513 oppose one another. Thereby, at least part of the upper surface 513T and the liquid mixture LD are brought into contact with one another, and the liquid mixture LD can clean at least part of the upper surface 513T.

After cleaning has been performed using the liquid mixture LD and before the exposure of the substrate P using the liquid LQ, the control apparatus 516 starts the flushing process, which includes the supply operation wherein the liquid LQ is supplied via the supply ports 529, to eliminate the liquid mixture LD from the liquid immersion member 514. In addition, the control apparatus 516 starts the recovery operation, wherein the liquid is recovered via the recovery port 530 (step S505).

In the state wherein the measurement stage 513 is disposed at a position at which it opposes the last optical element 521 and the liquid immersion member 514, the control apparatus 516 performs the recovery operation, which recovers the liquid via the liquid recovery port 530, in parallel with the supply operation, which supplies the liquid LQ via the liquid supply ports 529. Thereby, the control apparatus 516 can wash away the liquid mixture LD that remains on, for example, the upper surface 513T of the measurement stage 513 and the lower surface 523 of the liquid immersion member 514, as well as in the porous member 535, the supply passageways 531R, and the recovery passageway 534R. In addition, the recovery operation, wherein the liquid is recovered via the recovery port 530, is performed in parallel with the supply operation, wherein the liquid LQ is supplied via the supply ports 529, in the state wherein the substrate stage 512 is disposed at the position at which it opposes the last optical element 521 and the liquid immersion member 514; thereby, the control apparatus 516 can wash away the liquid mixture LD that remains on, for example, the upper surface 512T of the substrate stage 512. The recovery operation, wherein the liquid is recovered via the recovery port 530, is additionally performed in parallel with the supply operation, wherein the liquid LQ is supplied via the supply ports 529, in the state wherein the cleaning tool 501 is disposed at the position at which it opposes the last optical element 521 and the liquid immersion member 514; thereby, the control apparatus 516 can wash away the liquid mixture LD that remains in, for example, the cleaning tool 501.

In the present embodiment, the liquid LC and the liquid LQ are different types of liquids. Using the liquid LQ for exposure to eliminate the liquid mixture LD prior to the exposure of the substrate P prevents the liquid mixture LD (i.e., the liquid LC) from intermixing with the liquid LQ that fills the optical path during subsequent exposures of substrates P.

After the flushing process, the control apparatus 516 recovers the liquid on the upper surface 501A of the cleaning tool 501 by stopping the supply operation, wherein the liquid LQ is supplied via the supply ports 529, and performing the recovery operation, wherein the liquid is recovered via the recovery port 530, in the state wherein the cleaning tool 501 is disposed at the position at which it opposes the last optical element 521 and the liquid immersion member 514 (step S506).

After the liquid of the cleaning tool 501 has been sufficiently recovered, the cleaning tool 501 is unloaded from the substrate stage 512. To unload the cleaning tool 501 from the substrate stage 512, the control apparatus 516 moves the substrate stage 512 to the substrate exchange position. The control apparatus 516 uses the transport system 515 to unload the cleaning tool 501 from the substrate stage 512, which is disposed at the substrate exchange position (step S507). Once the cleaning tool 501 has been unloaded from the substrate stage 512, it is unloaded from the exposure apparatus EX (step S508). In the present embodiment, the process (step S506) of recovering the liquid on the upper surface 501A of the cleaning tool 501 is performed before the cleaning tool 501 has been unloaded from the substrate stage 512; this prevents the liquid from leaking out of the cleaning tool 501, scattering, and the like during the transport of the unloaded cleaning tool 501.

After the processes of the steps S501-S508 discussed above, which include the cleaning process using the cleaning tool 501, have ended, the substrate P is held by the substrate holding part 512H and undergoes the exposing process. Prescribed processes, such as a developing process, are then performed on the exposed substrate P.

According to the present embodiment as explained above, it is possible to use the cleaning tool 501 to efficiently and satisfactorily clean, for example, the liquid immersion member 514 inside the exposure apparatus EX. Accordingly, it is possible to prevent the occurrence of exposure failures that might otherwise be caused by the contamination of, for example, the liquid immersion member 514 and thereby to prevent the production of defective devices.

Furthermore, in the embodiments discussed above, the transport system 515, which is capable of transporting the substrate P, performs the operation of loading the cleaning tool 501 onto the substrate stage 512 and the operation of unloading the cleaning tool 501 from the substrate stage 512; however, a transport system for transporting the cleaning tool 501 may be provided separately from the transport system 515, which is capable of transporting the substrate P, and that transport system may be used to perform the operations of loading and unloading the cleaning tool 501. In addition, the operation of loading the cleaning tool 501 onto the substrate stage 512 and the operation of unloading the cleaning tool 501 from the substrate stage 512 may be performed by an operator.

In addition, in the embodiment discussed above, the cleaning tool 501 is moved to the position at which it opposes the last optical element 521 and the liquid immersion member 514 while the immersion space LS of the liquid LQ is maintained; however, the cleaning tool 501 may be moved to the position at which it opposes the last optical element 521 and the liquid immersion member 514 after the liquid LQ that forms the immersion space LS has been eliminated, and the immersion space LS of the liquid LQ may then be subsequently re-formed between the last optical element 521 and the liquid immersion member 514 on one side and the cleaning tool 501 on the other side by resuming the operations of supplying the liquid LQ and recovering the liquid.

In addition, in the embodiment discussed above, after the cleaning tool 501 has been moved to the position at which it opposes the last optical element 521 and the liquid immersion member 514—namely, during the performance of the cleaning operation wherein the cleaning tool 501 is used—the operations of supplying the liquid LQ and recovering the liquid are stopped; however, these operations may be performed. In such a case, to prevent a drop in the proportion of the liquid LC in the liquid mixture LD, the amount of the liquid LQ supplied or amount of the liquid recovered, or both, is preferably less than that supplied or recovered during the exposure of the substrate P.

In addition, in the embodiment discussed above, the operation of cleaning the upper surface 512T of the substrate stage 512 by forming the immersion space of the liquid mixture LD thereon and the operation of cleaning the upper surface 513T of the measurement stage 513 by forming the immersion space of the liquid mixture LD thereon are performed; however, either or both of these operations may be omitted.

### Fourth Embodiment

The following text explains a fourth embodiment. In the explanation below, constituent parts that are identical or equivalent to those in the embodiment discussed above are assigned identical symbols, and the explanations thereof are therefore abbreviated or omitted.

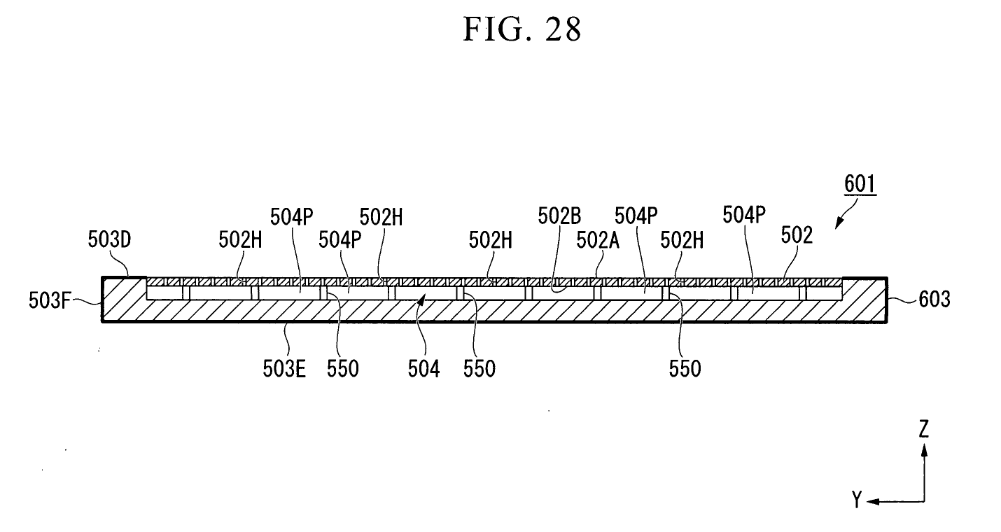

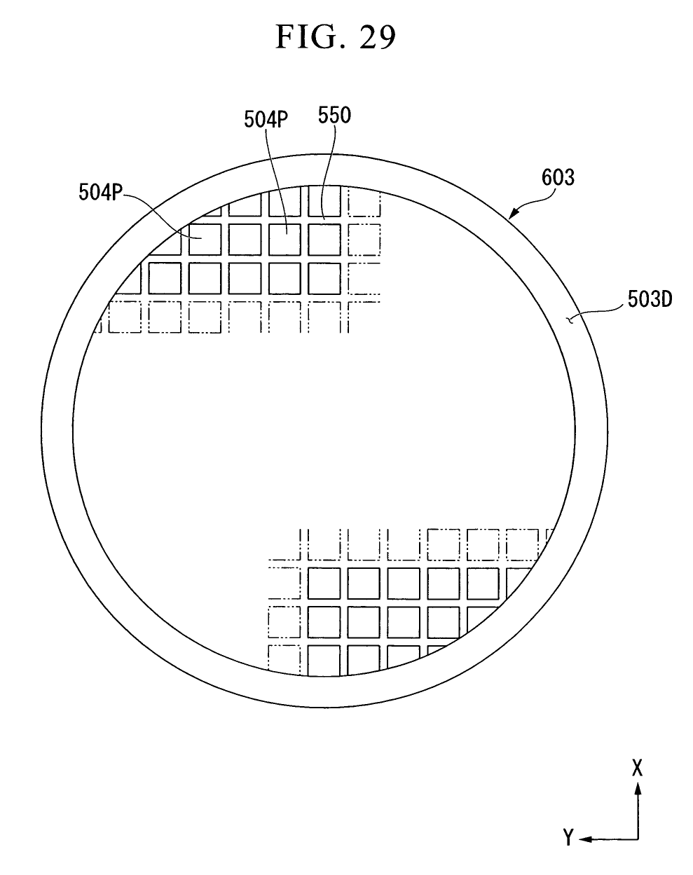

FIG. 28 is a side cross sectional view that shows one example of a cleaning tool 601 according to a second embodiment, and FIG. 29 is a partial plan view thereof. FIG. 29 shows the state wherein the porous plate 2 is absent.

In FIG. 28 and FIG. 29, the cleaning tool 601 comprises the porous plate 502 and a base member 603, which supports the porous plate 502. In addition, the cleaning tool 601 comprises the internal space 504, which faces the rear surface 502B of the porous plate 502.

In the present embodiment, the base member 603 has the same material properties as the porous plate 502. In the present embodiment, the base member 603 and the porous plate 502 are made of titanium. The porous plate 502 and the base member 603 are joined together. In the present embodiment, the porous plate 502 and the base member 603 are joined by the so-called diffusion welding method.

In the present embodiment, the outer surface of the base member 603 is formed from a resin film that contains fluorine. The outer surface of the base member 603 includes: the upper surface 503D of the base member 603, which is disposed around the front surface 502A of the porous plate 502; the lower surface 503E on the opposite side of the upper surface 503D; and a side surface 503F that connects the upper surface 503D and the lower surface 503E. Examples of materials with which the film is formed include tetrafluoroethylene-perfluoro (propyl vinyl ether)-copolymer (PFA), poly(tetrafluoroethylene) (PTFE), polyetheretherketone (PEEK), and Teflon®.

Because the outer surface of the base member 603 is formed from a resin film that contains fluorine, contamination of the transport member 524 is prevented, even if the transport member 524 has supported the base member 603. In addition, even if the substrate P is supported by the transport member 524 after the transport member 524 has supported the base member 603, the substrate P will be unaffected.

In the present embodiment, a porous member is not disposed in the internal space 504. In the present embodiment, segment members 550, which segment the internal space 504 into a plurality of spaces 504P, are disposed in the internal space 504. Before the cleaning process, the liquid LC for cleaning is disposed in the spaces 504P. In the present embodiment, the segment members 550 have the same material properties as the base member 603. Namely, in the present embodiment, the segment members 550 are made of titanium.

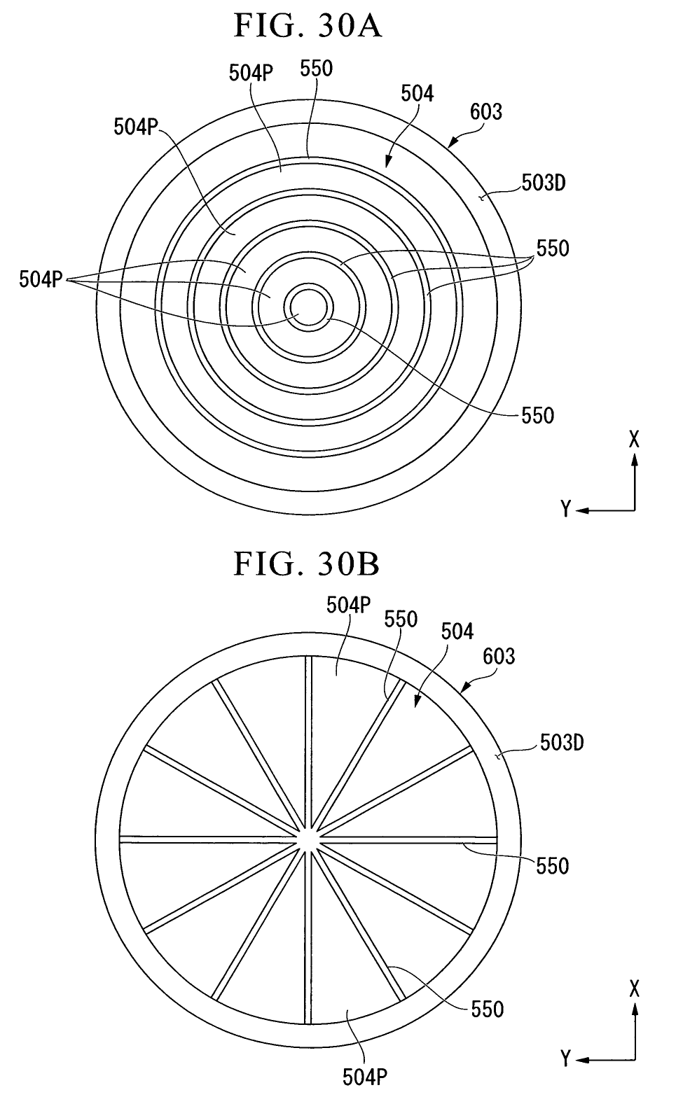

As shown in FIG. 29, in the present embodiment, the segment members 550 are disposed in a lattice shape within the XY plane, and the spaces 504P are disposed in a matrix within the XY plane. Furthermore, the segment members 550 may be disposed either in concentric circles with respect to the center of the base member 603 within the XY plane, as shown in FIG. 30A, or radially, as shown in FIG. 30B. By segmenting the internal space 504 into a plurality of spaces 504P, it is possible to prevent the liquid LC from leaking out of the spaces 504P during, for example, the transport of the cleaning tool 601. In addition, in the present embodiment, the porous member is not disposed in the internal space 504, and therefore the liquid LC can be satisfactorily excluded from the internal space 504 in, for example, the operations of the steps S505, S506 after the cleaning process (step S504) has been completed.

As explained above, in the present embodiment, the member to be cleaned inside the exposure apparatus EX can be cleaned efficiently and satisfactorily using the cleaning tool 501.

Also in the third and fourth embodiments, the supply of the cleaning liquid LC from the liquid supply source (not shown) to the cleaning member 3 can be executed inside the exposure apparatus EX. Also in this case, the cleaning liquid LC can be supplied from the liquid supply source to an upper surface of a member inside the exposure apparatus (e.g., the upper surface 512T of the substrate stage 512), so as to clean the upper surface of the member.

Furthermore, in the embodiments discussed above, the optical path on the emergent side (i.e., the image plane side) of the last optical element 521 of the projection optical system PL is filled with the liquid LQ, but it is also possible to employ a projection optical system wherein the optical path on the incident side (i.e., the object plane side) of the last optical element 521 is also filled with the liquid LQ, as disclosed in PCT International Publication WO2004/019128.

Furthermore, although the liquid LQ in each of the embodiments discussed above is water, it may be a liquid other than water. For example, it is also possible to use hydro-fluoro-ether (HFE), perfluorinated polyether (PFPE), Fomblin® oil, or the like as the liquid LQ. In addition, it is also possible to use various fluids, for example, a supercritical fluid, as the liquid LQ.

Furthermore, the substrate P in each of the embodiments discussed above is not limited to a semiconductor wafer for fabricating semiconductor devices, but can also be adapted to, for example, a glass substrate for display devices, a ceramic wafer for thin film magnetic heads, or the original plate of a mask or a reticle (i.e., synthetic quartz or a silicon wafer) used by an exposure apparatus.

The exposure apparatus EX may be a step-and-scan type scanning exposure apparatus (i.e., a scanning stepper), which scans and exposes the pattern of the mask M by synchronously moving the mask M and the substrate P, or a step-and-repeat type projection exposure apparatus (i.e., a stepper), which performs a full field exposure of the pattern of the mask M—with the mask M and the substrate P in a stationary state—and then sequentially steps the substrate P.

Furthermore, when performing an exposure with a step-and-repeat system, the projection optical system PL is used to transfer a reduced image of a first pattern onto the substrate P in a state wherein the first pattern and the substrate P are substantially stationary, after which the projection optical system PL may be used to perform a full-field exposure of the substrate P, wherein a reduced image of a second pattern partially superposes the transferred first pattern in a state wherein the second pattern and the substrate P are substantially stationary (i.e., as in a stitching type full-field exposure apparatus). In addition, a step-and-stitch type exposure apparatus can also be used as the stitching type exposure apparatus; in this case, at least two patterns are transferred onto the substrate P such that they partially overlap, and the substrate P is then sequentially stepped.

In addition, the exposure apparatus EX may be an exposure apparatus that combines on a substrate the patterns of two masks through a projection optical system and double exposes, substantially simultaneously, a single shot region on the substrate using a single scanning exposure, as disclosed in, for example, corresponding U.S. Pat. No. 6,611,316. In addition, the exposure apparatus EX may be a proximity type exposure apparatus or a mirror projection aligner.

In addition, in each of the embodiments discussed above, the exposure apparatus EX does not have to be provided with the measurement stage 13.

In addition, the exposure apparatus EX may be a twin stage type exposure apparatus, which comprises a plurality of substrate stages, as disclosed in, for example, U.S. Pat. Nos. 6,341,007, 6,208,407, and 6,262,796. In addition, the exposure apparatus EX may be an exposure apparatus that comprises a plurality of substrate stages and measurement stages.

Furthermore, as disclosed in, for example, U.S. Pat. No. 6,897,963, the present invention can also be adapted to an exposure apparatus that is provided with: a substrate stage, which holds the substrate; and a measurement stage that does not hold the substrate to be exposed and whereon a fiducial member (wherein a fiducial mark is formed), various photoelectric sensors, or the like, are mounted. In addition, the present invention can also be adapted to an exposure apparatus that comprises a plurality of substrate stages and measurement stages.

The type of exposure apparatus EX is not limited to a semiconductor device fabrication exposure apparatus that exposes the substrate P with the pattern of a semiconductor device, but can also be widely adapted to exposure apparatuses used to fabricate, for example, liquid crystal devices or displays, and to exposure apparatuses used to fabricate thin film magnetic heads, image capturing devices (CCDs), micromachines, MEMS devices, DNA chips, or reticles and masks.

Furthermore, in each of the embodiments discussed above, the positions of the mask stage 11 and the substrate stage 12 (512) are measured using an interferometer system that comprises laser interferometers, but the present invention is not limited thereto; for example, an encoder system may be used that detects a scale (i.e., diffraction grating) provided to each of the stages 11, 12 (512). In this case, a hybrid system that comprises both the interferometer system and the encoder system may also be adopted.

In addition, in each of the embodiments discussed above, an ArF excimer laser may be used as a light source apparatus that generates ArF excimer laser light, which serves as the exposure light EL; however, as disclosed in, for example, U.S. Pat. No. 7,023,610, a harmonic generation apparatus may be used that outputs pulsed light with a wavelength of 193 nm and that comprises: an optical amplifier part, which has a solid state laser light source (such as a DFB semiconductor laser or a fiber laser), a fiber amplifier, and the like; and a wavelength converting part. Moreover, in the abovementioned embodiments, both the illumination region IR and the projection region PR are rectangular, but they may be some other shape, for example, arcuate.

Furthermore, in each of the embodiments discussed above, an optically transmissive mask is used wherein a prescribed shielding pattern (or phase pattern or dimming pattern) is formed on an optically transmissive substrate; however, instead of such a mask, a variable pattern forming mask (also called an electronic mask, an active mask, or an image generator), wherein a transmissive pattern, a reflective pattern, or a light emitting pattern is formed based on electronic data of the pattern to be exposed, may be used as disclosed in, for example, U.S. Pat. No. 6,778,257. The variable pattern forming mask comprises a digital micromirror device (DMD), which is one kind of a non-emissive type image display device (e.g., a spatial light modulator). In addition, instead of a variable pattern forming mask that comprises a non-emissive type image display device, a pattern forming apparatus that comprises a self luminous type image display device may be provided. Examples of a self luminous type image display device include a cathode ray tube (CRT), an inorganic electroluminescence display, an organic electroluminescence display (OLED: organic light emitting diode), an LED display, a laser diode (LD) display, a field emission display (FED), and a plasma display panel (PDP).

Each of the embodiments discussed above explains an exemplary case of an exposure apparatus that comprises the projection optical system PL, but an exposure apparatus may be used that does not comprise the projection optical system PL. Thus, even if the projection optical system PL is not used, the exposure light can be radiated to the substrate through optical members, such as lenses, and an immersion space can be formed in a prescribed space between the substrate and those optical members.

In addition, by forming interference fringes on the substrate P as disclosed in, for example, PCT International Publication WO2001/035168, the exposure apparatus EX may be an exposure apparatus (i.e., a lithographic system) that exposes the substrate P with a line-and-space pattern.

As described above, the exposure apparatus EX of the present embodiment is manufactured by assembling various subsystems, as well as each constituent element recited in the claims of the present application, such that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the mechanical interconnection of the various subsystems, the wiring and connection of electrical circuits, and the piping and connection of the atmospheric pressure circuit. Naturally, prior to performing the process of assembling the exposure apparatus EX from these various subsystems, there are also the processes of assembling each individual subsystem. When the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room wherein, for example, the temperature and the cleanliness level are controlled.

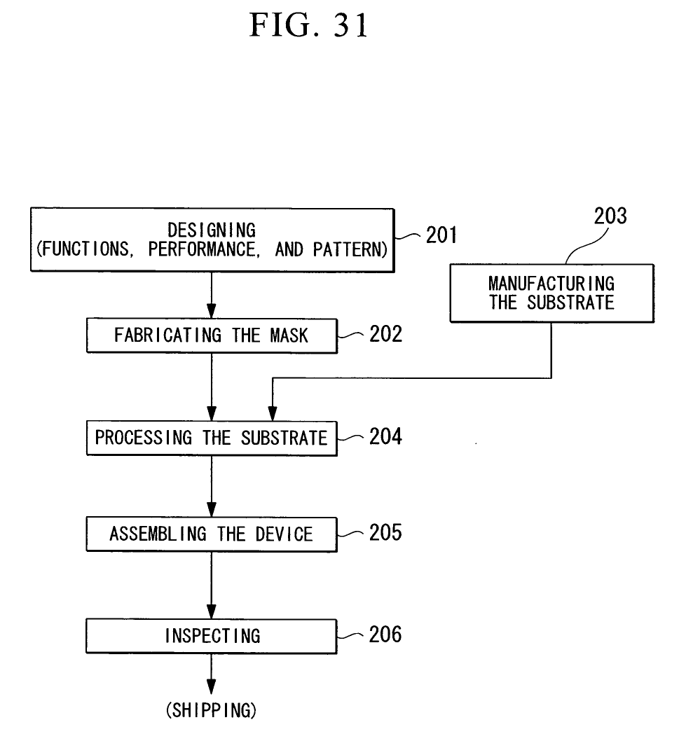

As shown in FIG. 31, a microdevice, such as a semiconductor device, is manufactured by: a step 201 that designs the functions and performance of the microdevice; a step 202 that fabricates a mask (i.e., a reticle) based on this designing step; a step 203 that manufactures a substrate, which is the base material of the device; a substrate processing step 204 that comprises a substrate process (i.e., an exposure process) that includes, in accordance with the embodiments discussed above, exposing the substrate P with the exposure light EL using the mask pattern and developing the exposed substrate P; a device assembling step 205 (which includes fabrication processes such as dicing, bonding, and packaging processes); an inspecting step 206; and the like. The process wherein the cleaning tool discussed above is used occurs during the substrate processing step 204.

Furthermore, the features of each of the embodiments discussed above can be combined as appropriate. In addition, there may be cases wherein some of the constituent elements are not used. In addition, each disclosure of every Japanese published patent application and U.S. patent related to the exposure apparatus recited in each of the embodiments, modified examples, and the like discussed above is hereby incorporated by reference in its entirety to the extent permitted by national laws and regulations.

What is claimed is:

1. A cleaning tool that is loaded onto an exposure apparatus, which exposes a substrate with an exposure light, and cleans a member inside the exposure apparatus, comprising:
a base member; and
a cleaning member that is disposed on the base member and permeated with a cleaning liquid.

2. A cleaning tool according to claim 1, wherein
the cleaning member comprises a first portion and a second portion.

3. A cleaning tool according to claim 2, wherein
the first portion has a first height with respect to a front surface of the base member; and
the second portion has a second height with respect to the front surface of the base member.

4. A cleaning tool according to claim 3, wherein
the second portion is higher than the first portion with respect to the front surface of the base member.

5. A cleaning tool according to claim 3, wherein
the first height and the second height are each prescribed in accordance with a profile of the front surface of the member inside the exposure apparatus.

6. A cleaning tool according to claim 2, wherein
the second portion is disposed at least partly around the first portion.

7. A cleaning tool according to claim 2, wherein
the first portion and the second portion are spaced apart on the base member.

8. A cleaning tool according to claim 2, wherein
the cleaning liquid includes a first cleaning liquid, which permeates the first portion, and a second cleaning liquid, which permeates the second portion.

9. A cleaning tool according to claim 1, further comprising:
a circumferential wall member that is disposed on the base member and around the cleaning member.

10. A cleaning tool according to claim 9, wherein
the circumferential wall member prevents the cleaning liquid from leaking out.

11. A cleaning tool according to claim 9, wherein
the circumferential wall member recovers the cleaning liquid that exudes from the cleaning member.

12. A cleaning tool according to claim 9, wherein
the circumferential wall member is a porous member.

13. A cleaning tool according to claim 9, wherein
the circumferential wall member is a sponge.

14. A cleaning tool according to claim 9, wherein
the circumferential wall member is shorter than the cleaning member with respect to the front surface of the base member.

15. A cleaning tool according to claim 9, wherein
the circumferential wall member is lyophilic with respect to the cleaning liquid from the cleaning member.

16. A cleaning tool according to claim 1, wherein
the base member has an external shape that is substantially the same as an external shape of the substrate.

17. A cleaning tool according to claim 1, wherein
the cleaning member is a porous member.

18. A cleaning tool according to claim 1, wherein
the cleaning member is a sponge.

19. A cleaning method, comprising the steps of:
loading a cleaning tool according to claim 1 onto an exposure apparatus, which exposes a substrate with an exposure light; and
cleaning at least part of a member inside the exposure apparatus by bringing the cleaning member of the cleaning tool and the member inside the exposure apparatus into contact with one another.

20. A cleaning method according to claim 19, comprising:
holding the cleaning tool with a substrate holding part inside the exposure apparatus; and
bringing the cleaning member and a front surface of the member inside the exposure apparatus into contact with one another by moving the substrate holding part.

21. A cleaning method according to claim 20, wherein
the member inside the exposure apparatus is cleaned in the state wherein the cleaning member is substantially stationary.

22. A cleaning method according to claim 19, wherein
the exposure apparatus is an immersion exposure apparatus that exposes the substrate through an exposure liquid; and
after cleaning is performed wherein the cleaning tool is used and before the exposure of the substrate, the exposure liquid is supplied to eliminate the cleaning liquid from the front surface of the member inside the exposure apparatus.

23. A cleaning method according to claim 19, wherein
the exposure apparatus is an immersion exposure apparatus that exposes the substrate through the exposure liquid; and
the front surface of the member inside the exposure apparatus includes at least one surface selected from the group consisting of: a holding surface that holds the exposure liquid between itself and the substrate during the exposure of the substrate; and a liquid recovery surface that is disposed at least partly around the holding surface.

24. A cleaning method according to claim 19, wherein
the front surface of the member inside the exposure apparatus includes an emergent surface of an optical member wherefrom the exposure light emerges.

25. A device fabricating method, comprising:
loading a cleaning tool according to claim 1 onto an exposure apparatus that exposes a substrate with an exposure light;
cleaning at least part of a member inside the exposure apparatus by bringing the cleaning member of the cleaning tool and the member inside the exposure apparatus into contact with one another;
after the cleaning, exposing a substrate using the exposure apparatus; and
developing the exposed substrate.

26. A device fabricating method according to claim 25, further comprising:
after the cleaning, holding the substrate with a substrate holding part; and
before the cleaning, holding the cleaning tool with the substrate holding part.

27. A cleaning tool that is loaded into an exposure apparatus, which exposes a substrate with exposure light through a first liquid, and cleans a prescribed member inside the exposure apparatus, comprising:
a porous plate that has a first surface, a second surface on the opposite side of the first surface, and a plurality of holes wherethrough the first surface and the second surface communicate;
a base member that supports the porous plate; and
an internal space that faces the second surface;
wherein,
a second liquid for cleaning is held in the internal space.

28. A cleaning tool according to claim 26, wherein
the second liquid is soluble in the first liquid.

29. A cleaning tool according to claim 28, wherein
the first surface is liquid repellent with respect to the first and second liquids.

30. A cleaning tool according to claim 27, wherein
the porous plate has the same material properties as the prescribed member.

31. A cleaning tool according to claim 27, wherein
the porous plate comprises a plurality of first protruding parts, which are disposed in a circumferential edge area of the second surface and protrude from the second surface, and a plurality of second protruding parts that corresponds to the plurality of first protruding parts, wherein each of the second protruding parts protrudes from its corresponding first protruding part outward in a radial direction with respect to the center of the second surface; and
the base member has a recessed part wherein the second protruding parts are disposed.

32. A cleaning tool according to claim 27, wherein
the base member is made of a ceramic material.

33. A cleaning tool according to claim 27, wherein
the base member has the same material properties as the porous plate.

34. A cleaning tool according to claim 33, wherein
the outer surface of the base member is formed from a resin film that contains fluorine.

35. A cleaning tool according to claim 27, further comprising:
a porous member, which is disposed in the internal space and has a plurality of open pores.

36. A cleaning tool according to claim 35, wherein
the porous member has the same material properties as the prescribed member.

37. A cleaning tool according to claim 27, further comprising:
segment members, which are disposed in the internal space and segment the internal space into a plurality of spaces.

38. A cleaning tool according to claim 37, wherein
the segment members have the same material properties as the base member.

39. A cleaning tool according to claim 27,
the cleaning tool has an external shape that is substantially the same as an external shape of the substrate.

40. A cleaning method, comprising:
loading a cleaning tool according to claim 26 into an exposure apparatus, which exposes a substrate with exposure light through a first liquid; and
cleaning a front surface of a prescribed member inside the exposure apparatus with a liquid mixture of the first liquid and the second liquid created on the first surface by bringing the first liquid and the first surface into contact with one another.

41. A cleaning method according to claim 40, wherein
the first surface of the cleaning tool is disposed at a position at which it opposes the front surface of an object inside the exposure apparatus; and
the liquid mixture is held between the first surface and the front surface of the object.

42. A cleaning method according to claim 41, wherein
the porous plate has the same material properties as the object.

43. A cleaning method according to claim 41, wherein
the front surface of the prescribed member includes the front surface of the object.

44. A cleaning method according to claim 41, wherein
the front surface of the prescribed member is disposed at least partly around the first surface.

45. A cleaning method according to claim 41, further comprising:
when cleaning using the liquid mixture, moving the object and the cleaning tool relative to one another.

46. A cleaning method according to claim 41, further comprising:
holding the cleaning tool with a movable member, which is capable of moving to an irradiation position of the exposure light and releasably holding the substrate; and
moving the movable member to dispose the first surface of the cleaning tool at a position at which it opposes the front surface of the object.

47. A cleaning method according to claim 40, further comprising:
performing at least one operation selected from the group consisting of: the loading operation, wherein the cleaning tool is supported by a transport member and loaded onto the movable member, and an unloading operation, wherein the cleaning tool is unloaded from the movable member;
wherein,
the transport member supports a base member of the cleaning tool.

48. A cleaning method according to claim 47, wherein
the transport member is capable of performing at least one operation selected from the group consisting of: a loading operation, wherein the substrate is supported and loaded onto the movable member, and an unloading operation, wherein the substrate is unloaded from the movable member.

49. A cleaning method according to claim 48, wherein
the acceleration when the transport member transports the cleaning tool is smaller than the acceleration when the transport member transports the substrate.

50. A cleaning method according to claim 40, further comprising:
after the cleaning wherein the liquid mixture is used and before the exposure of the substrate, supplying the first liquid to eliminate the liquid mixture from the prescribed member.

51. A cleaning method according to claim 40, further comprising:
after the cleaning wherein the liquid mixture is used, recovering a liquid on the first surface.

52. A cleaning method according to claim 51, further comprising:
after the recovery, unloading the cleaning tool from the exposure apparatus.

53. A cleaning method according to claim 40, wherein
the front surface of the prescribed member contacts the first liquid during the exposure of the substrate.

54. A cleaning method according to claim 40, wherein
the front surface of the prescribed member holds the first liquid between itself and the front surface of the substrate such that the optical path of the exposure light that impinges the substrate is filled with the first liquid during the exposure of the substrate.

55. A device fabricating method, comprising:
loading a cleaning tool according to claim 27 into an exposure apparatus, which exposes a substrate with exposure light through a first liquid; and
cleaning at least part of a prescribed member inside the exposure apparatus with a liquid mixture of the first liquid and the second liquid created on the first surface by bringing the first liquid and the first surface into contact with one another;
after the cleaning, exposing a substrate using the exposure apparatus; and
developing the exposed substrate.

56. A device fabricating method according to claim 55, further comprising:
after the cleaning, holding the substrate with a movable member, which is capable of moving to an irradiation position of the exposure light; and
before the cleaning, holding the cleaning tool with the movable member.

57. A cleaning tool that is loaded onto an exposure apparatus, which exposes a substrate with an exposure light, and cleans a member inside the exposure apparatus, comprising:
a base member; and
a liquid holding member that is provided on the base member and is capable of holding a cleaning liquid.

58. A cleaning tool according to claim 57, wherein
the liquid holding member comprises a porous member.

59. A cleaning tool according to claim 57, wherein
the liquid holding member forms an internal space in which the cleaning liquid is held.

60. A cleaning tool according to claim 57, wherein
the cleaning member is permeated with the cleaning liquid so that the cleaning liquid is held by the liquid holding member.

61. A cleaning method, comprising:
loading a cleaning tool according to claim 57 into an exposure apparatus, which exposes a substrate with exposure light; and
cleaning a front surface of a prescribed member inside the exposure apparatus with a cleaning liquid held by a liquid holding member of the cleaning tool.

62. A device fabricating method, comprising:
loading a cleaning tool according to claim 57 into an exposure apparatus, which exposes a substrate with exposure light; and
cleaning a front surface of a prescribed member inside the exposure apparatus with a cleaning liquid held by a liquid holding member of the cleaning tool;
after the cleaning, exposing a substrate using the exposure apparatus; and
developing the exposed substrate.
